(19) United States
(12) Patent Application Publication
(10) Pub. No.: US 2024/0211093 A1
(43) Pub. Date: Jun. 27, 2024

(54) Artificial Reality Coworking Spaces for Two-Dimensional and Three-Dimensional Interfaces

(71) Applicant: Meta Platforms Technologies, LLC, Menlo Park, CA (US)

(72) Inventors: James Anthony HUGHES, London (GB); Michael James LEBEAU, Amsterdam (NL); Håvard Alnes BOLAND, London (GB); Monica ESCRIBANO PERUCHA, Madrid (ES); Petra ZHIVKOVA, London (GB); Thomas ACTMAN, Bristol (GB); Marcus TANNER, Old Windsor (GB)

(21) Appl. No.: 18/522,628

(22) Filed: Nov. 29, 2023

Related U.S. Application Data
(60) Provisional application No. 63/491,884, filed on Mar. 23, 2023.
(60) Provisional application No. 63/476,410, filed on Dec. 21, 2022.

(51) Int. Cl. G06F 3/04815; G06F 3/01; G06T 19/00

(52) U.S. Cl. CPC G06F 3/04815; G06F 3/011; G06T 19/006; G06T 2200/24

(57) ABSTRACT

Aspects of the present disclosure can allow users to participate in artificial reality (XR) coworking spaces on two-dimensional (2D) interfaces, such as computers, mobile devices, etc. Users can join a “quiet” virtual coworking space in which they can see representations of other users within the space (including XR users), but without sound. From the virtual coworking space, a user can request to start a conversation with another user, which can send a non-audible notification to the other user, thus being less intrusive to the other user. The other user can join the conversation at their convenience, and be transported to a virtual conference room with the requesting user to engage in audio and/or video discussion. Other users within the virtual coworking space can see the attendees within the virtual conference room, and join the virtual conference room by being invited, or simply clicking to join, without permission needed.

### CROSS-REFERENCE TO RELATED APPLICATIONS

This application claims priority to U.S. Provisional Patent Application No. 63/476,410, filed Dec. 21, 2022, titled “Dynamic Artificial Reality Coworking Spaces”; and U.S. Provisional Patent Application No. 63/491,884, filed Mar. 23, 2023, titled “Artificial Reality Coworking Spaces for Two-Dimensional and Three-Dimensional Interfaces”; and is related to U.S. Patent Application No. ______ filed Nov. 29, 2023, titled “Dynamic Artificial Reality Coworking Spaces” having attorney Docket No. 3589-0181US01; all of which are herein incorporated by reference in their entireties.

### TECHNICAL FIELD

The present disclosure is directed to computing systems providing A) dynamic artificial reality (XR) coworking spaces, and B) XR coworking spaces for two-dimensional (2D) and three-dimensional (3D) interfaces.

### BACKGROUND

Artificial reality (XR) devices are becoming more prevalent. As they become more popular, the applications implemented on such devices are becoming more sophisticated. Augmented reality (AR) applications can provide interactive 3D experiences that combine images of the real-world with virtual objects, while virtual reality (VR) applications can provide an entirely self-contained 3D computer environment. For example, an AR application can be used to superimpose virtual objects over a video feed of a real scene that is observed by a camera. A real-world user in the scene can then make gestures captured by the camera that can provide interactivity between the real-world user and the virtual objects. Mixed reality (MR) systems can allow light to enter a user's eye that is partially generated by a computing system and partially includes light reflected off objects in the real-world. AR, MR, and VR experiences can be observed by a user through a head-mounted display (HMD), such as glasses or a headset.

In recent years, remote working has become more prevalent. Although remote working can be more convenient for many people, productivity and creativity can decrease without the ease of in-person collaboration. Thus, applications have been developed that allow users to virtually work together (e.g., via video conferencing) to give the feel of in-person working, despite the users' remote locations.

### BRIEF DESCRIPTION OF THE DRAWINGS

FIG. 1 is a block diagram illustrating an overview of devices on which some implementations of the present technology can operate.

FIG. 2A is a wire diagram illustrating a virtual reality headset which can be used in some implementations of the present technology.

FIG. 2B is a wire diagram illustrating a mixed reality headset which can be used in some implementations of the present technology.

FIG. 2C is a wire diagram illustrating controllers which, in some implementations, a user can hold in one or both hands to interact with an artificial reality environment.

FIG. 3 is a block diagram illustrating an overview of an environment in which some implementations of the present technology can operate.

FIG. 4 is a block diagram illustrating components which, in some implementations, can be used in a system employing the disclosed technology.

FIG. 5 is a flow diagram illustrating a process used in some implementations of the present technology for providing a dynamic artificial reality (XR) coworking space on an XR device.

FIG. 6 is a conceptual diagram illustrating an example overhead view of a dynamic XR coworking space.

FIG. 7A is a conceptual diagram illustrating an example view of a virtual workspace of a user from the user's XR device.

FIG. 7B is a conceptual diagram illustrating an example view of a dynamic XR coworking space from a user's XR device.

FIG. 7C is a conceptual diagram illustrating an example view of a combined virtual workspace from a user's XR device.

FIG. 7D is a conceptual diagram illustrating an example view of a virtual menu to join a combined virtual workspace from a user's XR device.

FIG. 7E is a conceptual diagram illustrating an example view of a gesture by a user to join a combined virtual meeting room from a user's XR device.

FIG. 7F is a conceptual diagram illustrating an example view of a combined virtual meeting room from a user's XR device.

FIG. 7G is a conceptual diagram illustrating an example view of a combined virtual meeting room with video conferencing participants from a user's XR device.

FIG. 8 is a flow diagram illustrating a process used in some implementations of the present technology for providing an XR coworking space on a two-dimensional (2D) interface.

FIG. 9A is a conceptual diagram illustrating an example view of an XR coworking space on a 2D interface.

FIG. 9B is a conceptual diagram illustrating an example view of a virtual conference room on a 2D interface.

FIG. 9C is a conceptual diagram illustrating an example view of an XR coworking space on a 2D interface while a user is within a virtual conference room.

FIG. 9D is a conceptual diagram illustrating an example view of an XR coworking space on a 2D interface when a user has sent an invitation to join a virtual conference room.

FIG. 10 is a conceptual diagram illustrating an example view on a 2D interface when an XR coworking space has been minimized.

FIG. 11A is a conceptual diagram illustrating an example view, of an XR coworking space on a three-dimensional (3D) interface, of 2D representations of users accessing the XR coworking space from 2D interfaces.

FIG. 11B is a conceptual diagram illustrating an example view, of an XR coworking space on a 3D interface, of a 3D representation of a user accessing the XR coworking space from a 2D interface.

The techniques introduced here may be better understood by referring to the following Detailed Description in conjunction with the accompanying drawings, in which like reference numerals indicate identical or functionally similar elements.

### DETAILED DESCRIPTION

Some aspects of the present disclosure are directed to providing a dynamic artificial reality (XR) coworking space on a three-dimensional (3D) interface, such as an XR device (e.g., an XR head-mounted display (HMD)). Some aspects of the present disclosure can map a virtual desk corresponding to a user's real-world desk into a virtual working space. The virtual working space can include pods of individual workspaces with each user sitting at their real-world desk (some of which may be remote from each other) and seeing into their coworkers' individual virtual workspaces in virtual reality (VR). Thus, some implementations can provide a user with awareness of others doing personal work.

Some implementations can allow users to merge their individual virtual workspaces into a shared virtual workspace, such as a shared virtual meeting table in the virtual workspace. For example, a user can merge their virtual workspace by inviting another user to merge virtual workspaces and, upon acceptance, some implementations can map each user's real-world desk to the shared virtual meeting table in VR. Once the shared virtual meeting table is formed, other users can join, causing the shared virtual meeting table to further expand in the virtual workspace. In some implementations, users can choose to move the meeting to a private virtual meeting room that is not visible to others in the virtual workspace.

Some aspects of the present disclosure can allow users to participate in artificial reality (XR) coworking spaces on two-dimensional (2D) interfaces, such as computers, mobile devices, etc. Users on 2D interfaces can join a “quiet” virtual coworking space in which they can see representations (e.g., avatars, video streams, etc.) of other users within the space (including representations of users on 3D interfaces), but without sound. From the “quiet” virtual coworking space, a user can request to start a conversation with another user, which can send a non-audible notification to the other user, thus being less intrusive to the other user. The other user can join the conversation at their convenience (e.g., within a 5-minute period), and be transported to a virtual conference room with the requesting user to engage in audio and/or video discussion.

In some implementations, the user creating the virtual conference room can add a title for the conversation, e.g., “coffee chat,” giving context to users in the “quiet” virtual coworking space of what is being discussed in the virtual conference room. Other users within the “quiet” virtual coworking space can see the attendees within the virtual conference room, and join the virtual conference room by one of two methods: 1) being invited by the current attendees, or 2) simply clicking to join, without permission needed. Thus, the “quiet” virtual coworking space can allow users to jump in and out of virtual conference rooms as they're working throughout the day, which can be beneficial for teams that are highly collaborative. Thus, some implementations described herein can advantageously provide an XR coworking space that can be accessed by both 2D and 3D interfaces, with users on both interfaces being able to interact with each other.

Implementations of the present technology provide specific technological improvements in the field of networked remote working via disparate computing devices. Conventionally, users working within the workplace can meet in-person, and include remote users via 2D videoconferencing and/or teleconferencing. Similarly, fully remote workers can only hold scheduled meetings via 2D videoconferencing and/or teleconferencing. Some implementations provide a remote working system in which both in-person and remote users can work while visualizing each other working (and, in some implementations, in a 3D immersive environment), thereby providing more realistic coworking and increasing productivity. Some implementations can allow users to seamlessly join each other and meet “on-the-fly” without a set meeting time or specific meeting link, and at the convenience of the individual users, thereby improving on traditional videoconferencing systems. In addition, some implementations provide for a coworking environment for users on both 2D and 3D interfaces, allowing for seamless integration of disparate computing devices having differing capabilities.

Embodiments of the disclosed technology may include or be implemented in conjunction with an artificial reality system. Artificial reality or extra reality (XR) is a form of reality that has been adjusted in some manner before presentation to a user, which may include, e.g., virtual reality (VR), augmented reality (AR), mixed reality (MR), hybrid reality, or some combination and/or derivatives thereof. Artificial reality content may include completely generated content or generated content combined with captured content (e.g., real-world photographs). The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted display (HMD) connected to a host computer system, a standalone HMD, a mobile device or computing system, a “cave” environment or other projection system, or any other hardware platform capable of providing artificial reality content to one or more viewers.

“Virtual reality” or “VR,” as used herein, refers to an immersive experience where a user's visual input is controlled by a computing system. “Augmented reality” or “AR” refers to systems where a user views images of the real world after they have passed through a computing system. For example, a tablet with a camera on the back can capture images of the real world and then display the images on the screen on the opposite side of the tablet from the camera. The tablet can process and adjust or “augment” the images as they pass through the system, such as by adding virtual objects. “Mixed reality” or “MR” refers to systems where light entering a user's eye is partially generated by a computing system and partially composes light reflected off objects in the real world. For example, a MR headset could be shaped as a pair of glasses with a pass-through display, which allows light from the real world to pass through a waveguide that simultaneously emits light from a projector in the MR headset, allowing the MR headset to present virtual objects intermixed with the real objects the user can see. “Artificial reality,” “extra reality,” or “XR,” as used herein, refers to any of VR, AR, MR, or any combination or hybrid thereof.

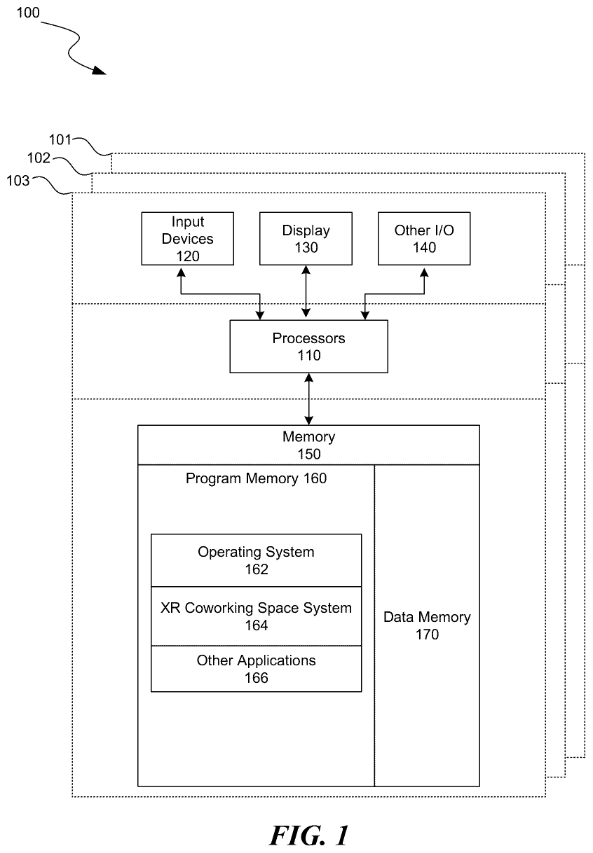

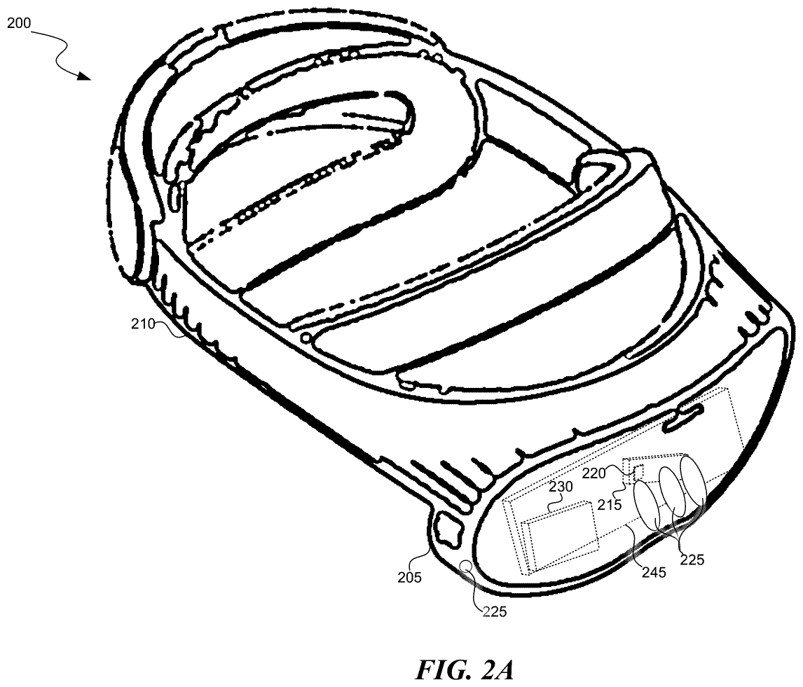

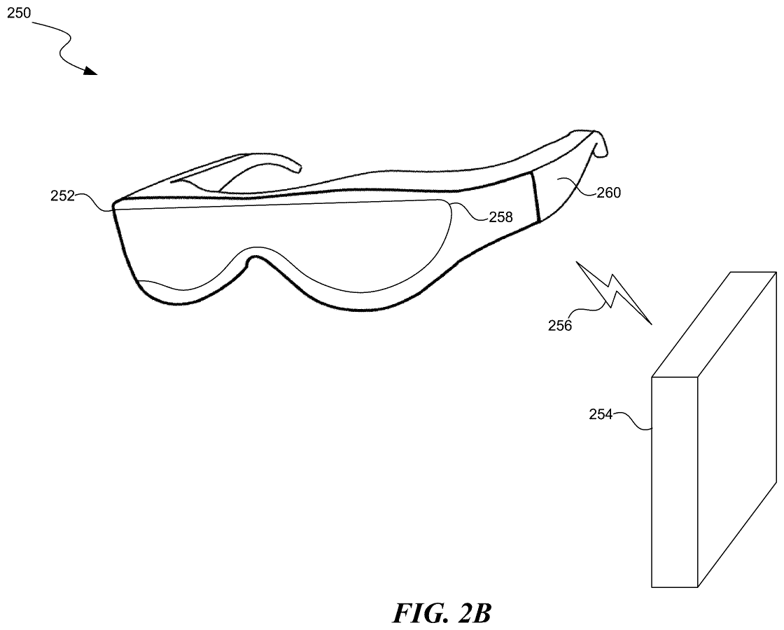

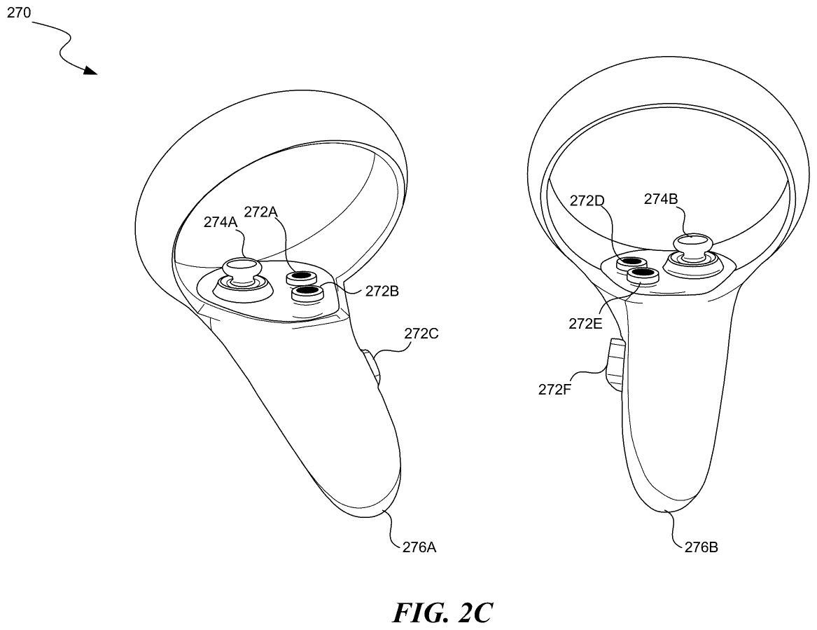

Several implementations are discussed below in more detail in reference to the figures. FIG. 1 is a block diagram illustrating an overview of devices on which some implementations of the disclosed technology can operate. The devices can comprise hardware components of a computing system 100 that, in some implementations, can provide a dynamic artificial reality (XR) coworking space on a three-dimensional (3D) interface, such as an XR device (an XR head-mounted display (HMD)), and/or an XR coworking space for a two-dimensional (2D) interface. In various implementations, computing system 100 can include a single computing device 103 or multiple computing devices (e.g., computing device 101, computing device 102, and computing device 103) that communicate over wired or wireless channels to distribute processing and share input data. In some implementations, computing system 100 can include a stand-alone headset capable of providing a computer created or augmented experience for a user without the need for external processing or sensors. In other implementations, computing system 100 can include multiple computing devices such as a headset and a core processing component (such as a console, mobile device, or server system) where some processing operations are performed on the headset and others are offloaded to the core processing component. Example headsets are described below in relation to FIGS. 2A and 2B. In some implementations, position and environment data can be gathered only by sensors incorporated in the headset device, while in other implementations one or more of the non-headset computing devices can include sensor components that can track environment or position data.

Computing system 100 can include one or more processor(s) 110 (e.g., central processing units (CPUs), graphical processing units (GPUs), holographic processing units (HPUs), etc.) Processors 110 can be a single processing unit or multiple processing units in a device or distributed across multiple devices (e.g., distributed across two or more of computing devices 101-103).

Computing system 100 can include one or more input devices 120 that provide input to the processors 110, notifying them of actions. The actions can be mediated by a hardware controller that interprets the signals received from the input device and communicates the information to the processors 110 using a communication protocol. Each input device 120 can include, for example, a mouse, a keyboard, a touchscreen, a touchpad, a wearable input device (e.g., a haptics glove, a bracelet, a ring, an earring, a necklace, a watch, etc.), a camera (or other light-based input device, e.g., an infrared sensor), a microphone, or other user input devices.

Processors 110 can be coupled to other hardware devices, for example, with the use of an internal or external bus, such as a PCI bus, SCSI bus, or wireless connection. The processors 110 can communicate with a hardware controller for devices, such as for a display 130. Display 130 can be used to display text and graphics. In some implementations, display 130 includes the input device as part of the display, such as when the input device is a touchscreen or is equipped with an eye direction monitoring system. In some implementations, the display is separate from the input device. Examples of display devices are: an LCD display screen, an LED display screen, a projected, holographic, or augmented reality display (such as a heads-up display device or a head-mounted device), and so on. Other I/O devices 140 can also be coupled to the processor, such as a network chip or card, video chip or card, audio chip or card, USB, firewire or other external device, camera, printer, speakers, CD-ROM drive, DVD drive, disk drive, etc.

In some implementations, input from the I/O devices 140, such as cameras, depth sensors, IMU sensor, GPS units, LiDAR or other time-of-flights sensors, etc. can be used by the computing system 100 to identify and map the physical environment of the user while tracking the user's location within that environment. This simultaneous localization and mapping (SLAM) system can generate maps (e.g., topologies, girds, etc.) for an area (which may be a room, building, outdoor space, etc.) and/or obtain maps previously generated by computing system 100 or another computing system that had mapped the area. The SLAM system can track the user within the area based on factors such as GPS data, matching identified objects and structures to mapped objects and structures, monitoring acceleration and other position changes, etc.

Computing system 100 can include a communication device capable of communicating wirelessly or wire-based with other local computing devices or a network node. The communication device can communicate with another device or a server through a network using, for example, TCP/IP protocols. Computing system 100 can utilize the communication device to distribute operations across multiple network devices.

The processors 110 can have access to a memory 150, which can be contained on one of the computing devices of computing system 100 or can be distributed across of the multiple computing devices of computing system 100 or other external devices. A memory includes one or more hardware devices for volatile or non-volatile storage, and can include both read-only and writable memory. For example, a memory can include one or more of random access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. Memory 150 can include program memory 160 that stores programs and software, such as an operating system 162, an artificial reality (XR) coworking space system 164 that, in some implementations, can include a dynamic XR coworking space system for three-dimensional (3D) interfaces and/or an XR coworking space system for two-dimensional (2D) interfaces, and other application programs 166. Memory 150 can also include data memory 170 that can include, e.g., image data, physical object attribute data, rendering data, mapping data, 2D interface data, 3D interface data, representation data, conversation data, audio data, video data, XR coworking space data, virtual conference room data, configuration data, settings, user options or preferences, etc., which can be provided to the program memory 160 or any element of the computing system 100.

Some implementations can be operational with numerous other computing system environments or configurations. Examples of computing systems, environments, and/or configurations that may be suitable for use with the technology include, but are not limited to, XR headsets, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

FIG. 2A is a wire diagram of a virtual reality head-mounted display (HMD) 200, in accordance with some embodiments. In this example, HMD 200 also includes augmented reality features, using passthrough cameras 225 to render portions of the real world, which can have computer generated overlays. The HMD 200 includes a front rigid body 205 and a band 210. The front rigid body 205 includes one or more electronic display elements of one or more electronic displays 245, an inertial motion unit (IMU) 215, one or more position sensors 220, cameras and locators 225, and one or more compute units 230. The position sensors 220, the IMU 215, and compute units 230 may be internal to the HMD 200 and may not be visible to the user. In various implementations, the IMU 215, position sensors 220, and cameras and locators 225 can track movement and location of the HMD 200 in the real world and in an artificial reality environment in three degrees of freedom (3 DoF) or six degrees of freedom (6 DoF). For example, locators 225 can emit infrared light beams which create light points on real objects around the HMD 200 and/or cameras 225 capture images of the real world and localize the HMD 200 within that real world environment. As another example, the IMU 215 can include e.g., one or more accelerometers, gyroscopes, magnetometers, other non-camera-based position, force, or orientation sensors, or combinations thereof, which can be used in the localization process. One or more cameras 225 integrated with the HMD 200 can detect the light points. Compute units 230 in the HMD 200 can use the detected light points and/or location points to extrapolate position and movement of the HMD 200 as well as to identify the shape and position of the real objects surrounding the HMD 200.

The electronic display(s) 245 can be integrated with the front rigid body 205 and can provide image light to a user as dictated by the compute units 230. In various embodiments, the electronic display 245 can be a single electronic display or multiple electronic displays (e.g., a display for each user eye). Examples of the electronic display 245 include: a liquid crystal display (LCD), an organic light-emitting diode (OLED) display, an active-matrix organic light-emitting diode display (AMOLED), a display including one or more quantum dot light-emitting diode (QOLED) sub-pixels, a projector unit (e.g., microLED, LASER, etc.), some other display, or some combination thereof.

In some implementations, the HMD 200 can be coupled to a core processing component such as a personal computer (PC) (not shown) and/or one or more external sensors (not shown). The external sensors can monitor the HMD 200 (e.g., via light emitted from the HMD 200) which the PC can use, in combination with output from the IMU 215 and position sensors 220, to determine the location and movement of the HMD 200.

FIG. 2B is a wire diagram of a mixed reality HMD system 250 which includes a mixed reality HMD 252 and a core processing component 254. The mixed reality HMD 252 and the core processing component 254 can communicate via a wireless connection (e.g., a 60 GHz link) as indicated by link 256. In other implementations, the mixed reality system 250 includes a headset only, without an external compute device or includes other wired or wireless connections between the mixed reality HMD 252 and the core processing component 254. The mixed reality HMD 252 includes a pass-through display 258 and a frame 260. The frame 260 can house various electronic components (not shown) such as light projectors (e.g., LASERs, LEDs, etc.), cameras, eye-tracking sensors, MEMS components, networking components, etc.

The projectors can be coupled to the pass-through display 258, e.g., via optical elements, to display media to a user. The optical elements can include one or more waveguide assemblies, reflectors, lenses, mirrors, collimators, gratings, etc., for directing light from the projectors to a user's eye. Image data can be transmitted from the core processing component 254 via link 256 to HMD 252. Controllers in the HMD 252 can convert the image data into light pulses from the projectors, which can be transmitted via the optical elements as output light to the user's eye. The output light can mix with light that passes through the display 258, allowing the output light to present virtual objects that appear as if they exist in the real world.

Similarly to the HMD 200, the HMD system 250 can also include motion and position tracking units, cameras, light sources, etc., which allow the HMD system 250 to, e.g., track itself in 3 DoF or 6 DoF, track portions of the user (e.g., hands, feet, head, or other body parts), map virtual objects to appear as stationary as the HMD 252 moves, and have virtual objects react to gestures and other real-world objects.

FIG. 2C illustrates controllers 270 (including controller 276A and 276B), which, in some implementations, a user can hold in one or both hands to interact with an artificial reality environment presented by the HMD 200 and/or HMD 250. The controllers 270 can be in communication with the HMDs, either directly or via an external device (e.g., core processing component 254). The controllers can have their own IMU units, position sensors, and/or can emit further light points. The HMD 200 or 250, external sensors, or sensors in the controllers can track these controller light points to determine the controller positions and/or orientations (e.g., to track the controllers in 3 DoF or 6 DoF). The compute units 230 in the HMD 200 or the core processing component 254 can use this tracking, in combination with IMU and position output, to monitor hand positions and motions of the user. The controllers can also include various buttons (e.g., buttons 272A-F) and/or joysticks (e.g., joysticks 274A-B), which a user can actuate to provide input and interact with objects.

In various implementations, the HMD 200 or 250 can also include additional subsystems, such as an eye tracking unit, an audio system, various network components, etc., to monitor indications of user interactions and intentions. For example, in some implementations, instead of or in addition to controllers, one or more cameras included in the HMD 200 or 250, or from external cameras, can monitor the positions and poses of the user's hands to determine gestures and other hand and body motions. As another example, one or more light sources can illuminate either or both of the user's eyes and the HMD 200 or 250 can use eye-facing cameras to capture a reflection of this light to determine eye position (e.g., based on set of reflections around the user's cornea), modeling the user's eye and determining a gaze direction.

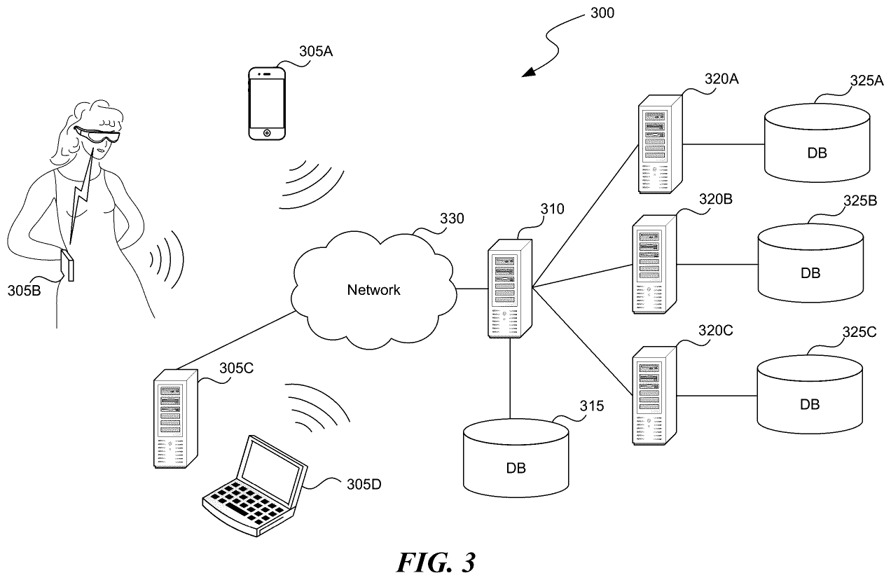

FIG. 3 is a block diagram illustrating an overview of an environment 300 in which some implementations of the disclosed technology can operate. Environment 300 can include one or more client computing devices 305A-D, examples of which can include computing system 100. In some implementations, some of the client computing devices (e.g., client computing device 305B) can be the HMD 200 or the HMD system 250. Client computing devices 305 can operate in a networked environment using logical connections through network 330 to one or more remote computers, such as a server computing device.

In some implementations, server 310 can be an edge server which receives client requests and coordinates fulfillment of those requests through other servers, such as servers 320A-C. Server computing devices 310 and 320 can comprise computing systems, such as computing system 100. Though each server computing device 310 and 320 is displayed logically as a single server, server computing devices can each be a distributed computing environment encompassing multiple computing devices located at the same or at geographically disparate physical locations.

Client computing devices 305 and server computing devices 310 and 320 can each act as a server or client to other server/client device(s). Server 310 can connect to a database 315. Servers 320A-C can each connect to a corresponding database 325A-C. As discussed above, each server 310 or 320 can correspond to a group of servers, and each of these servers can share a database or can have their own database. Though databases 315 and 325 are displayed logically as single units, databases 315 and 325 can each be a distributed computing environment encompassing multiple computing devices, can be located within their corresponding server, or can be located at the same or at geographically disparate physical locations.

Network 330 can be a local area network (LAN), a wide area network (WAN), a mesh network, a hybrid network, or other wired or wireless networks. Network 330 may be the Internet or some other public or private network. Client computing devices 305 can be connected to network 330 through a network interface, such as by wired or wireless communication. While the connections between server 310 and servers 320 are shown as separate connections, these connections can be any kind of local, wide area, wired, or wireless network, including network 330 or a separate public or private network.

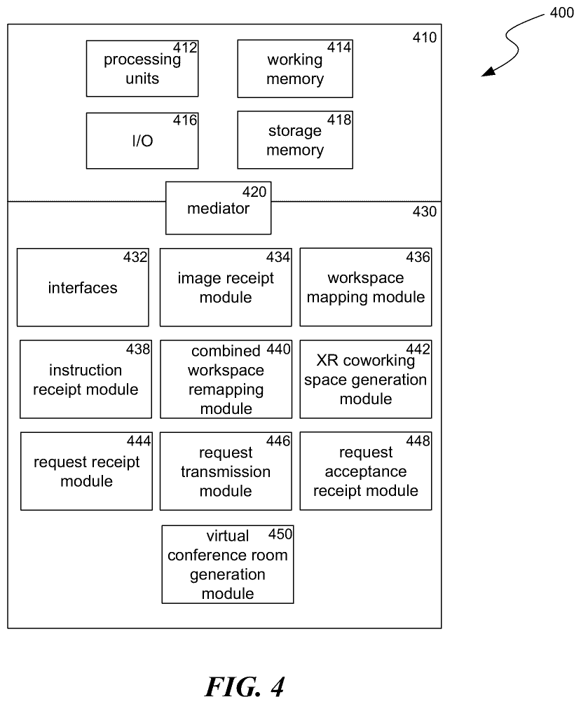

FIG. 4 is a block diagram illustrating components 400 which, in some implementations, can be used in a system employing the disclosed technology. Components 400 can be included in one device of computing system 100 or can be distributed across multiple of the devices of computing system 100. The components 400 include hardware 410, mediator 420, and specialized components 430. As discussed above, a system implementing the disclosed technology can use various hardware including processing units 412, working memory 414, input and output devices 416 (e.g., cameras, displays, IMU units, network connections, etc.), and storage memory 418. In various implementations, storage memory 418 can be one or more of: local devices, interfaces to remote storage devices, or combinations thereof. For example, storage memory 418 can be one or more hard drives or flash drives accessible through a system bus or can be a cloud storage provider (such as in storage 315 or 325) or other network storage accessible via one or more communications networks. In various implementations, components 400 can be implemented in a client computing device such as client computing devices 305 or on a server computing device, such as server computing device 310 or 320.

Mediator 420 can include components which mediate resources between hardware 410 and specialized components 430. For example, mediator 420 can include an operating system, services, drivers, a basic input output system (BIOS), controller circuits, or other hardware or software systems.

In some implementations, specialized components 430 can include software or hardware configured to perform operations for providing a dynamic artificial reality (XR) coworking space on a three-dimensional (3D) interface, such as an XR device (e.g., an XR head-mounted display (HMD)). In such implementations, specialized components 430 can include image receipt module 434, workspace mapping module 436, instruction receipt module 438, combined workspace remapping module 440, and components and APIs which can be used for providing user interfaces, transferring data, and controlling the specialized components, such as interfaces 432.

In some implementations, specialized components 430 can include software or hardware configured to perform operations for providing an XR coworking space on a two-dimensional interface (2D), such as a screen of a computing device, a mobile phone display, a television screen, etc. In such implementations, specialized components 430 can include XR coworking space generation module 442, request receipt module 444, request transmission module 446, request acceptance receipt module 448, virtual conference room generation module 450, and components and APIs which can be used for providing user interfaces, transferring data, and controlling the specialized components, such as interfaces 432.

In some implementations, specialized components 430 can include software or hardware configured to perform operations for both providing a dynamic XR coworking space on a 3D interface and providing an XR coworking space on a two-dimensional (2D) interface. In such implementations, special components 430 can include all of image receipt module 434, workspace mapping module 436, instruction receipt module 438, combined workspace remapping module 440, XR coworking space generation module 442, request receipt module 444, request transmission module 446, request acceptance receipt module 448, virtual conference room generation module 450, and components and APIs which can be used for providing user interfaces, transferring data, and controlling the specialized components, such as interfaces 432.

In some implementations, components 400 can be in a computing system that is distributed across multiple computing devices or can be an interface to a server-based application executing one or more of specialized components 430. Although depicted as separate components, specialized components 430 may be logical or other nonphysical differentiations of functions and/or may be submodules or code-blocks of one or more applications.

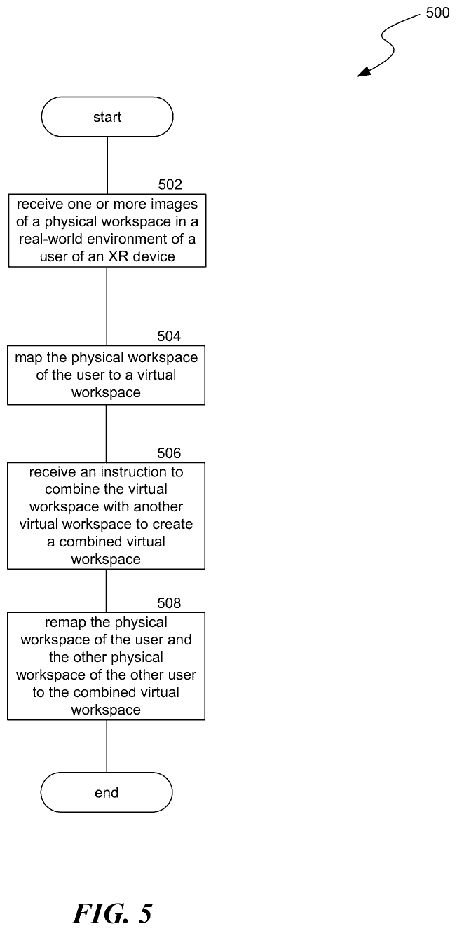

Image receipt module 434 can receive one or more images of a physical workspace in a real-world environment of a user of an XR device (e.g., an XR head-mounted display (HMD), such as XR HMD 200 of FIG. 2A and/or XR HMD 252 of FIG. 2B). In some implementations, the one or more images can be captured by a camera integral with the XR device and transmitted to image receipt module 434 via a network, such as network 330 of FIG. 3. In some implementations, the one or more images can be captured by an image capture device external to and in operable communication with the XR device. The physical workspace of the user can include a first real-world object (e.g., a virtual desk or table). In some implementations, image receipt module 434 and/or the XR device can identify the first real-world object from the one or more images using object recognition techniques. In some implementations, image receipt module 434 can identify the first real-world object from data collected by one or more controllers (e.g., controllers 270), e.g., when the user of the XR device places the one or more controllers on the real-world object and identifies the first real-world object (e.g., as a desk, as a tabletop, etc.). Further details regarding receiving one or more images of a physical workspace in a real-world environment of a user are described herein with respect to block 502 of FIG. 5.

Workspace mapping module 436 can map, using the one or more images, the physical workspace of the user to a virtual workspace in a dynamic XR coworking space, such that a surface of the first real-world object corresponds to a surface of a first virtual object in the virtual workspace. For example, workspace mapping module 436 can use the one or more images to identify a size of the first real-world object and scale the first virtual object such that locations on the first real-world object have corresponding locations on the first virtual object. Thus, for example, a user can make motions and/or take actions with respect to the first real-world object, and corresponding virtual motions and/or actions can be made in the proper locations with respect to the first virtual object. Further details regarding mapping the physical workspace of a user to a virtual workspace in a dynamic XR coworking space are described herein with respect to block 504 of FIG. 5.

Instruction receipt module 438 can receive an instruction to combine A) the virtual workspace with B) another virtual workspace, to create a combined virtual workspace. The other virtual workspace can be mapped to another physical workspace or another user, such that a surface of a second real-world object corresponds to a surface of a second virtual object in the other virtual workspace. Instruction receipt module 438 can receive the instruction over a network, e.g., network 330 of FIG. 3. The instruction received by instruction receipt module 438 can be generated by an XR device associated with the user or the other user by, for example, detection of a gesture by one user toward the other user (e.g., pointing), selection of one user by the other user (e.g., using a controller, from a virtual menu, from a virtual seat map, from a virtual list, etc.). Further details regarding receiving an instruction to form a combined virtual workspace are described herein with respect to block 506 of FIG. 5.

Combined workspace remapping module 440 can, in response to the instruction received by instruction receipt module 438, remap the physical workspace of the user and the other physical workspace of the other user to the combined virtual workspace, such that the surface of the first real-world object and the surface of the second real-world object correspond to one or more surfaces of one or more third virtual objects in the combined virtual workspace. For example, combined workspace remapping module 440 can remap the user's physical desk to a location on a virtual meeting table, and remap the other user's physical desk to another location on the virtual meeting table. Thus, motions and/or actions taken by each user with respect to their physical desks can cause corresponding virtual motions and/or actions with respect to the virtual meeting table. Further details regarding remapping a physical workspace of the user and another physical workspace of another user to a combined virtual workspace are described herein with respect to block 508 of FIG. 5.

XR coworking space generation module 442 can generate an XR coworking space for rendering on two-dimensional (2D) and three-dimensional (3D) interfaces. The 2D interfaces can be electronic interfaces designed to display 2D content items, such as, for example, a desktop computer, a laptop computer, a tablet, a mobile phone or other mobile device, etc. The 3D interfaces can be electronic interfaces designed to display 3D environments and/or content items, such as XR devices (e.g., XR HMDs, such as XR HMD 200 of FIG. 2A and/or XR HMD 252 of FIG. 2B). The XR coworking space can be accessed by users via such interfaces, with the XR coworking space being rendered in 2D on the 2D interfaces, and being rendered in 2D and/or 3D on the 3D interfaces.

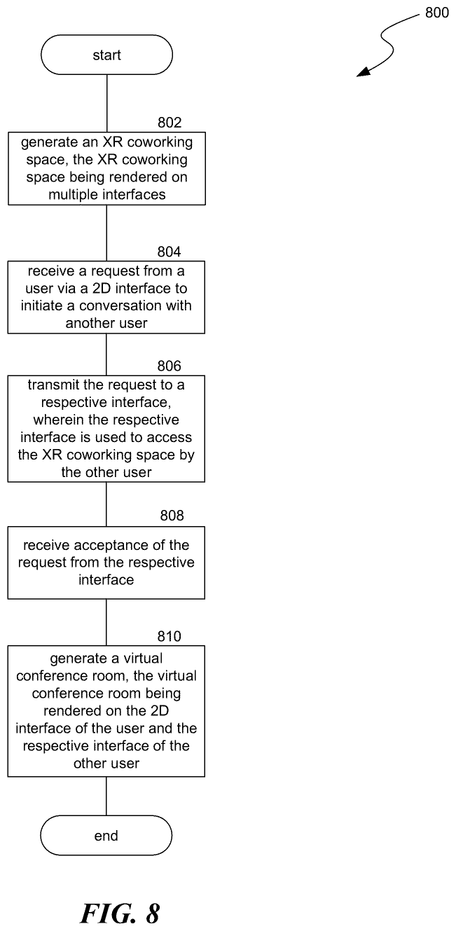

In some implementations, XR coworking space generation module 442 can generate the XR coworking space without audio, and/or the 2D and 3D interfaces can render the XR coworking space without audio. In some implementations, however, XR coworking space generation module 442 can generate the XR coworking space with audio, and/or the 2D and 3D interfaces can render the XR coworking space with audio. In some implementations, XR coworking space generation module 442 can generate the XR coworking space with representations of the users within the space, such as their names, photographs, avatars, video streams, etc. Further details regarding generating an XR coworking space are described herein with respect to block 802 of FIG. 8.

Request receipt module 444 can receive a request from a user of a 2D interface to initiate a conversation with another user. The other user can be a user of a 2D interface or a user of a 3D interface. The user of the 2D interface can transmit the request to request receipt module 444 over any suitable network, such as network 330 of FIG. 3, which can include WiFi, a cellular network, a local area network (LAN), etc., or any combination thereof. The user can make the request via the 2D interface by, for example, selecting a physical and/or virtual button associated with requesting a conversation with the other user. In some implementations, the user can make the request via the 2D interface by selecting a representation (e.g., an avatar, a photograph, a video stream, etc.) of the other user displayed in the XR coworking space. Further details regarding receiving a request from a user to initiate a conversation with another user are described herein with respect to block 804 of FIG. 8.

Request transmission module 446 can transmit the request, received by request receipt module 444, to a respective interface used to access the XR coworking space by the other user. Request transmission module 446 can transmit the request to the respective interface over any suitable network, such as network 330 of FIG. 3, which can include WiFi, a cellular network, a local area network (LAN), etc., or any combination thereof. Request transmission module 446 can transmit the request over a same or different network from which request receipt module 444 received the request. In some implementations, request transmission module 446 can transmit the request such that it is rendered silently on the respective interface of the other user, e.g., visually without any audible notification, such that it is less intrusive to the other user. Further details regarding transmitting a request to initiate a conversation to a respective interface used to access an XR coworking space by another user are described herein with respect to block 806 of FIG. 8.

Request acceptance receipt module 448 can receive acceptance of the request transmitted by request transmission module 446 from the other user via the respective interface. Request acceptance receipt module 448 can receive acceptance of the request via any suitable network, such as network 330 of FIG. 3, which can be the same or a different network from which request receipt module 444 received the request and/or request transmission module 446 transmitted the request. The other user can accept the request via the respective interface by, for example, selecting a virtual and/or physical button associated with acceptance (e.g., using a mouse, using a touchscreen, using a controller, such as one or more of controllers 276A-276B of FIG. 2C, etc.), audibly announcing acceptance of the request as captured by a microphone included in the respective interface, by performing a gesture (e.g., a check mark drawn with the finger, a thumbs up, etc.) captured by a camera and/or one or more sensors (e.g., of an inertial measurement unit (IMU)) and/or electromyography (EMG) sensor included in the respective interface or in operable communication with the respective interface (e.g., as included in a wearable device)), etc., or any combination thereof. Further details regarding receiving acceptance, by another user of a respective interface, of a request to initiate a conversation made by a user of a 2D interface, are described herein with respect to block 808 of FIG. 8.

Virtual conference room generation module 450 can, based on the acceptance of the request received by request acceptance receipt module 448, generate a virtual conference room for the user and the other user. The 2D interface of the user and the respective interface of the other user, which can be a 2D or 3D interface, can render the virtual conference room. The virtual conference room can have audio capabilities, such that the user and the other user can audibly communicate with each other within the virtual conference room, which, in some implementations, they were not able to do in the XR coworking space generated by XR coworking space generation module 442. In some implementations, virtual conference room generation module 450 can further generate the virtual conference room with video feeds of the user and/or the other user. In some implementations, virtual conference room generation module 450 can generate the virtual conference room with an animated feed of an avatar of the other user, which, in some implementations, can be a representation of the other user captured by a 3D interface.

It is contemplated that any number of other users within the XR coworking space can join the virtual conference room via any of a number of methods. For example, users within the XR coworking space can simply select a displayed option to join the virtual conference room, without permission needed from one or more of the attendees in the virtual conference room. However, in some implementations, virtual conference room generation module 450 can generate the virtual conference room as a private virtual conference room, such that users within the XR coworking space must request to join the room and receive acceptance from one or more of the current attendees (e.g., the user creating the private virtual conference room, one or more of the other users within the private virtual conference room, all of the users within the private virtual conference room, etc.). In some implementations, a current attendee of the virtual conference room can invite other users within the XR coworking space to join the virtual conference room, which the users can accept or decline at their convenience. Further details regarding generating a virtual conference room are described herein with respect to block 810 of FIG. 8.

Those skilled in the art will appreciate that the components illustrated in FIGS. 1-4 described above, and in each of the flow diagrams discussed below, may be altered in a variety of ways. For example, the order of the logic may be rearranged, substeps may be performed in parallel, illustrated logic may be omitted, other logic may be included, etc. In some implementations, one or more of the components described above can execute one or more of the processes described below.

FIG. 5 is a flow diagram illustrating a process 500 used in some implementations for providing a dynamic artificial reality (XR) coworking space on a three-dimensional interface, such as an XR device (e.g., an XR head-mounted display (HMD), such as XR HMD 200 of FIG. 2A and/or XR HMD 252 of FIG. 2B). In some implementations, process 500 can be performed as a response to a user request to join a dynamic XR coworking space. In some implementations, process 500 can be performed as a response to a user request to generate a virtual workspace within the dynamic XR coworking space. In some implementations, process 500 can be performed as a response to execution of an application on an XR device, by an XR HMD and/or one or more other components of an XR system, such as one or more external processing components. In some implementations, process 500 can be performed by a remote computing system, e.g., a platform or developer computing system (e.g., a server) located remotely from the XR device. In some implementations, process 500 can be performed by XR coworking space system 164 of FIG. 1. In some implementations, process 500 can be performed by a subset of specialized components 430 of FIG. 4.

At block 502, process 500 can receive one or more images of a physical workspace in a real-world environment of a user of an XR device. In some implementations, the one or more images can be captured by the XR device, e.g., using one or more cameras integral with the XR device. In some implementations, the one or more images can be captured by an external image capture device in operable communication with the XR device. The physical workspace of the user can be, for example, an office or other physical room where work can be performed. The physical workspace of the user can include a first real-world object, e.g., a desk, a table, items on the desk or table, etc.

At block 504, process 500 can map, using the one or more images, the physical workspace of the user to a virtual workspace in the dynamic XR coworking space. The virtual workspace can be, for example, a virtual office, a virtual cubicle, and/or another virtual space where a user can perform work. In some implementations, process 500 can map the physical workspace of the user to the virtual workspace such that a surface of the first real-world object corresponds to a surface of a first virtual object in the virtual workspace. For example, process 500 can map a physical office to a virtual cubicle such that a surface of a physical desk corresponds to a surface of a virtual desk in the virtual cubicle, such that actions taken by the user of the XR device on the physical desk are made in a corresponding location on the virtual desk.

At block 506, process 500 can receive an instruction to combine A) the virtual workspace with B) another virtual workspace, in order to create a combined virtual workspace. In some implementations, the instruction can be made by the user via a gesture detected by the XR device. For example, the user can point at an avatar of the other user and/or the other virtual workspace in order to generate the instruction. In another example, the user can use a controller (e.g., one or more of controllers 270 of FIG. 2C) to select the avatar of the other user and/or the other virtual workspace in order to generate the instruction. Process 500 can map the other virtual workspace to another physical workspace of another user, such that a surface of a second real-world object corresponds to a surface of a second virtual object in the other virtual workspace.

In some implementations, process 500 can receive, from the XR device, a selection of an avatar of the other user, the other virtual workspace of the other user, or both, such as through a gesture detected by a camera integral with the XR device, a selection on a controller, etc. In response to the selection, process 500 can transmit an invitation to create a combined virtual workspace to another XR device of the other user. The other XR device can generate the instruction to create the combined virtual workspace upon acceptance of the other XR device of the other user.

At block 508, in response to the instruction, process 500 can remap the physical workspace of the user and the other physical workspace of the other user to the combined virtual workspace. Process 500 can remap the physical workspace and the other physical workspace such that the surface of the first real-world object and the surface of the second real-world object correspond to one or more surfaces of one or more third virtual objects in the combined virtual workspace, e.g., a virtual meeting table having areas corresponding to the real-world desks of the user and the other user.

The XR device and the other XR device can render the combined virtual workspace. In some implementations, the combined virtual workspace can be larger than the virtual workspace of the user. In some implementations, the combined virtual workspace can correlate to the size of added virtual workspaces, e.g., if the steps of process 500 are performed once, the combined virtual workspace can be the size of the virtual workspace plus the size of the other virtual workspace. However, it is contemplated that some or all of the steps of process 500 can be performed more than once, such that multiple virtual workspaces can be remapped into the combined virtual workspace. Thus, for example, if five users request to add their virtual workspace to the combined virtual workspace, the combined virtual workspace can be the size of the areas of the individual virtual workspaces combined.

In implementations in which the dynamic XR coworking space includes multiple other virtual workspaces of other users, at least one of the other users can join the combined virtual workspace such that at least one of the multiple other virtual workspaces corresponding to the at least one of the other users are joined to the combined virtual workspace. In some implementations, only users meeting predefined criteria can join the combined virtual workspace. The predefined criteria can be, for example, users that are friends of the user, users having avatars within a threshold virtual distance of the avatar of the user, users having avatars within the field-of-view of the user, users assigned to a same group or team as the user, users with similar job functions, users with similar demographics, etc.

In some implementations, the combined virtual workspace can be an extension of the virtual workspace of the user, i.e., the virtual workspace of the user can be pushed out to accommodate the added virtual workspace of the other user. In some implementations, the dynamic XR coworking space can include multiple other virtual workspaces of other users. In some implementations, the virtual workspace can be extended into the combined virtual workspace through an outer virtual wall of the dynamic XR coworking space, such that the combined virtual workspace does not encroach on the multiple other virtual workspaces of the other users.

In some implementations, process 500 can assign the XR device and the other XR device to a cluster. In some implementations, process 500 can receive and transmit audio signals within the cluster, e.g., talking between the users associated with the XR device and the other XR device. In some implementations, the audio signals are not transmitted outside of the cluster, e.g., are not transmitted to other XR devices associated with other virtual workspaces in the dynamic XR coworking space that are not in the cluster. Thus, the users associated with the XR device and the other XR device, who are within the combined workspace, can have personal conversations not heard by users outside of the combined workspace. In some implementations, the combined virtual workspace can be visible on one or more XR devices outside of the cluster, e.g., the combined virtual workspace can be a virtual room having transparent or translucent walls, such that other users can see the combined virtual workspace and the avatars (or other representations) of users within the combined virtual workspace. In some implementations, the combined virtual workspace cannot be visible to one or more XR devices outside of the cluster, e.g., the combined virtual workspace can be a private virtual meeting room having opaque walls and/or barriers blocking the view into the virtual meeting room.

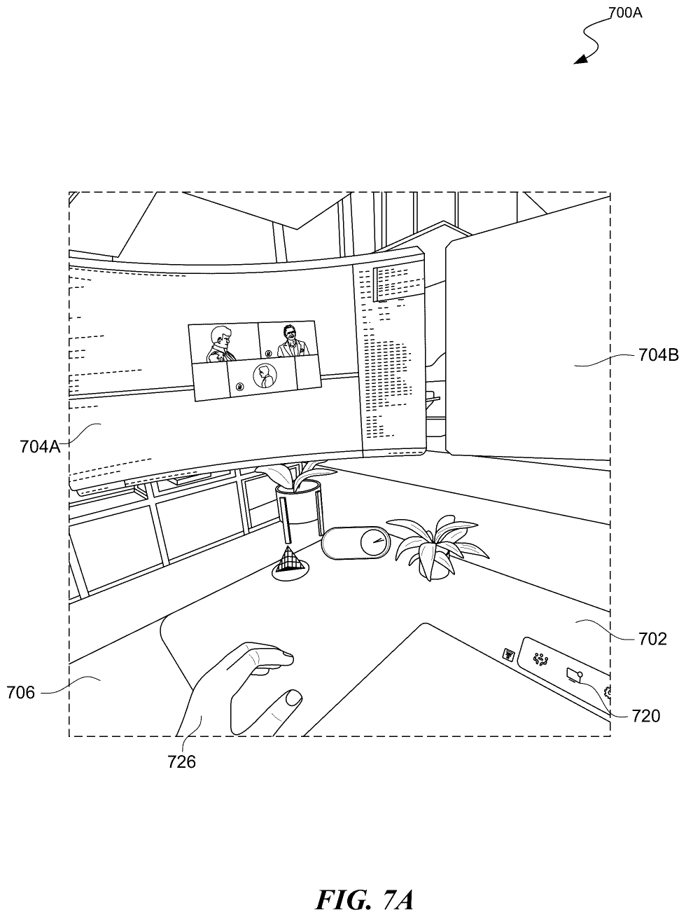

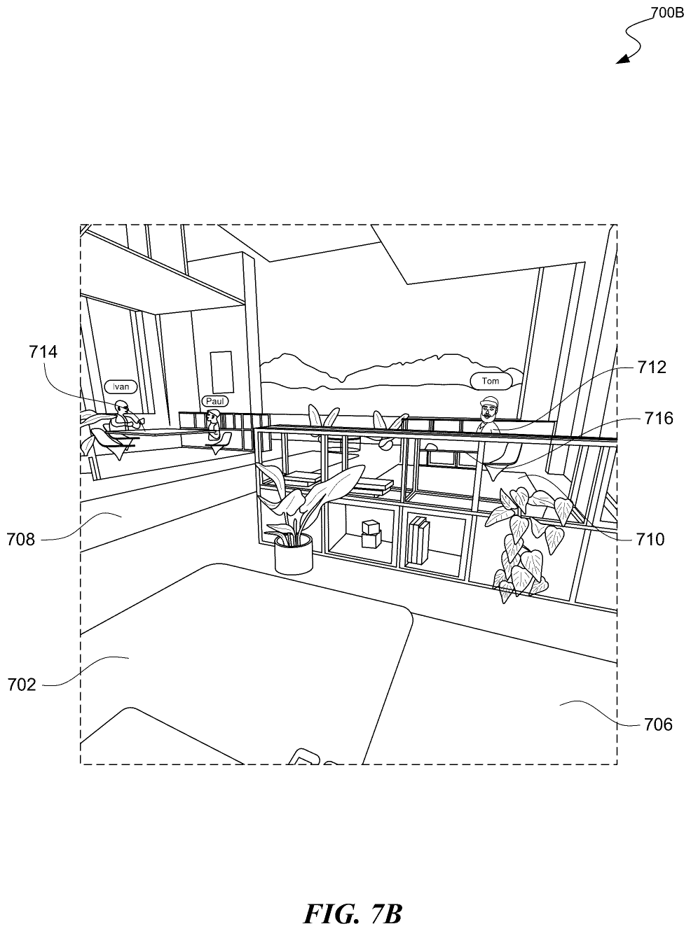

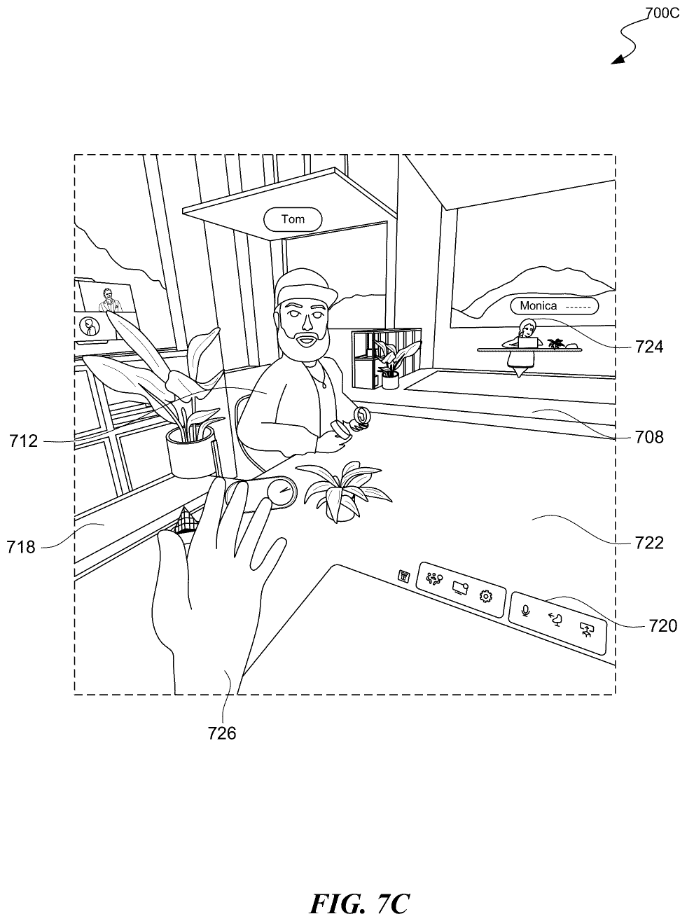

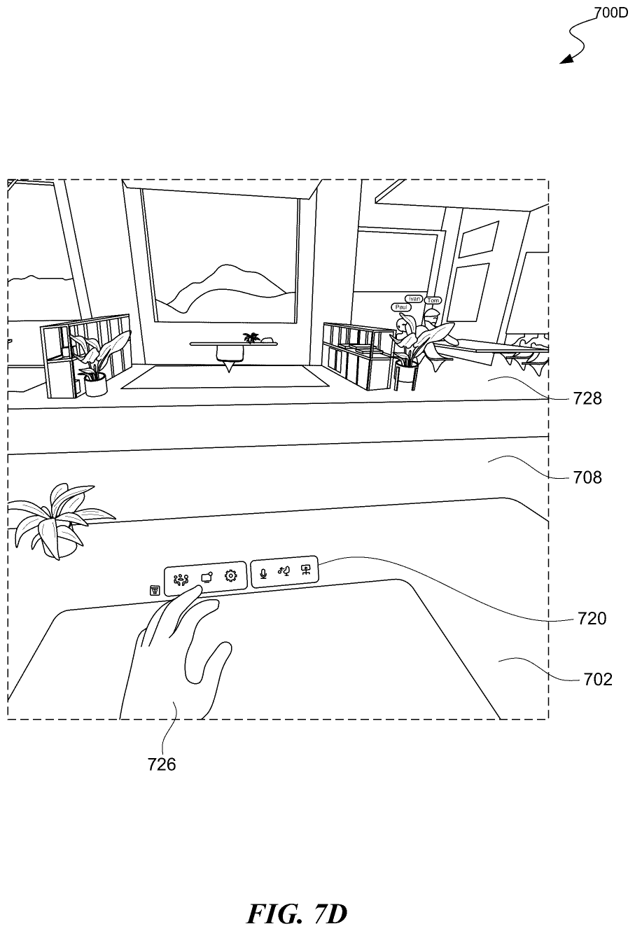

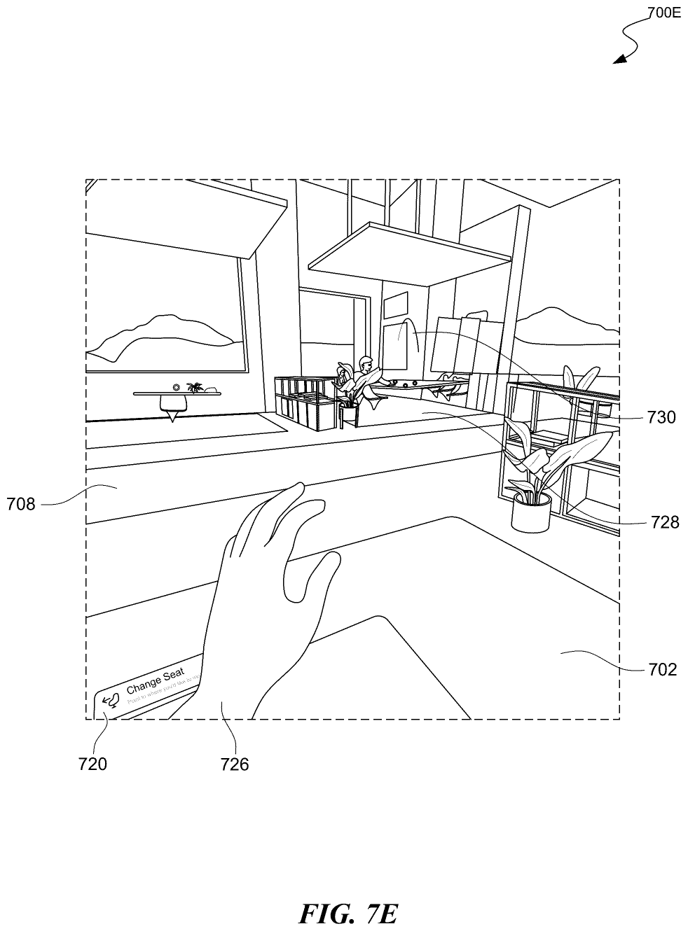

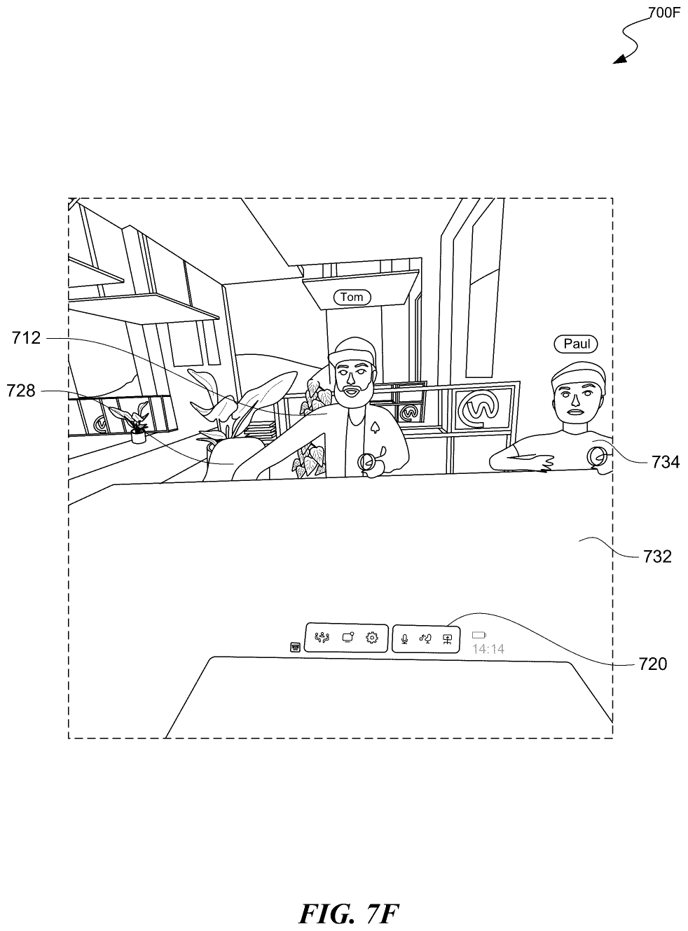

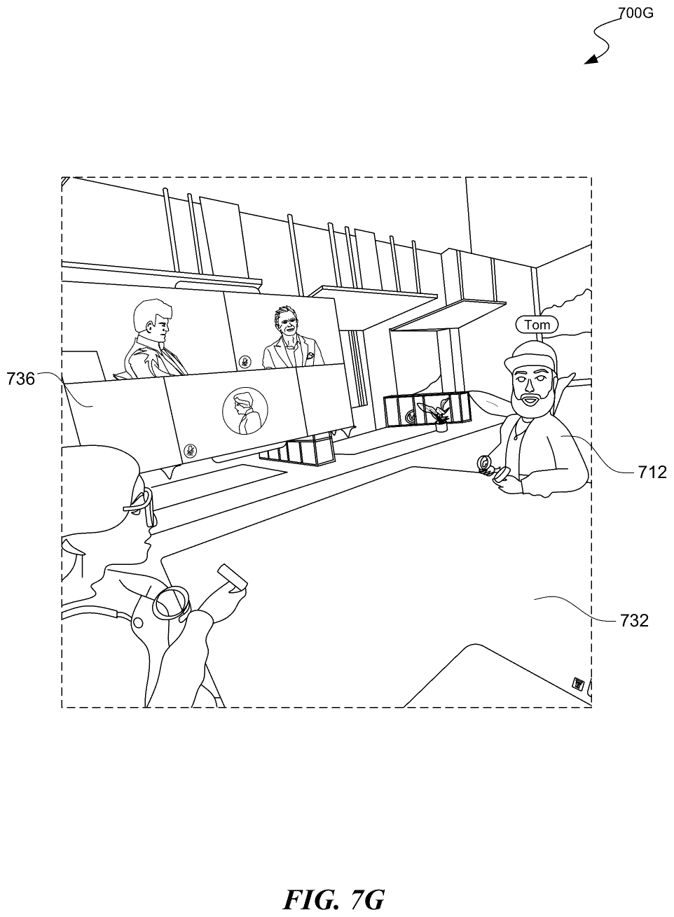

In some implementations, process 500 can map one or more video conference feeds to the combined virtual workspace. For example, the XR device and the other XR device can be in a virtual meeting room with one or more virtual televisions or other virtual display screens displaying video conference feeds of other users. Further details regarding mapping video conference feeds to a combined virtual workspace are described herein with respect to FIG. 7G.

In some implementations, process 500 can receive a selection from the XR device to exit the combined virtual workspace. For example, the user can select (e.g., via a gesture, selection of a physical button on a controller, a selection from a virtual menu, etc.) to return to their individual virtual workspace. Process 500 can then remap the physical workspace of the user back to the virtual workspace of the user. In some implementations, the other XR device can render a shrunken combined virtual workspace, e.g., can revert to their individual virtual workspace. While virtual workspaces are added or removed from the combined virtual workspace, the combined virtual workspace can grow or shrink accordingly.

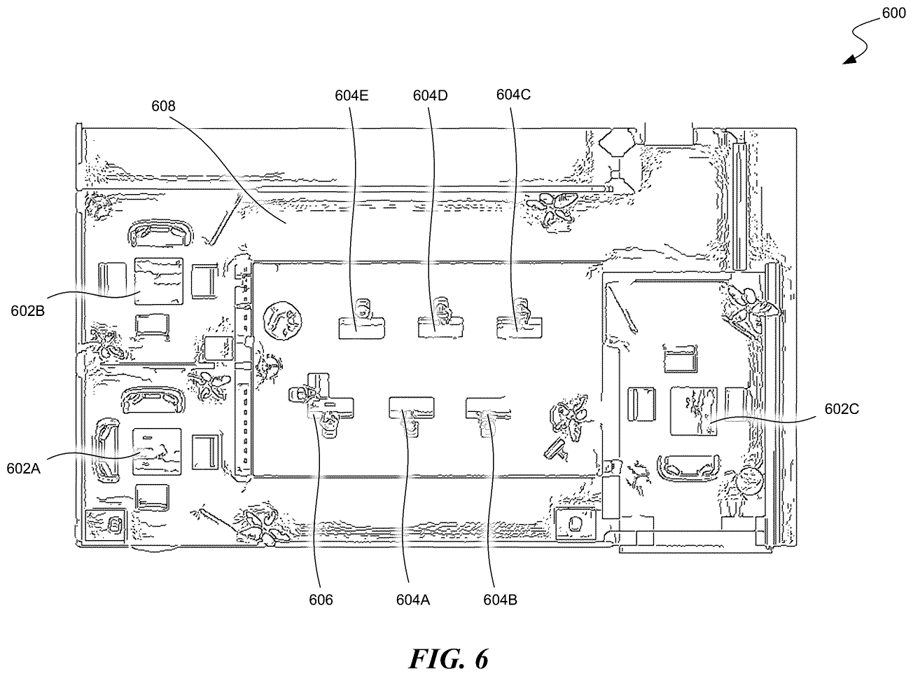

FIG. 6 is a conceptual diagram illustrating an example overhead view 600 of a dynamic artificial reality coworking space 608. Dynamic artificial reality coworking space 608 can include virtual meeting rooms 602A-C, individual virtual workspaces 604A-E, and combined virtual workspace 606. Combined virtual workspace 606 can be formed, for example, when a user of an XR device (e.g., an XR HMD) selects to combine their individual virtual workspace with the virtual workspace of another user, as described further herein with respect to FIG. 7C.

FIG. 7A is a conceptual diagram illustrating an example view 700A of a virtual workspace 706 of a user from the user's XR device, such as an XR HMD. Virtual workspace 706 can include virtual desk 702 (e.g., a first virtual object) and virtual screens 704A-B for performing work by the user. The user of the XR device can be sitting at a real-world desk (e.g., a first real-world object). Some implementations can map the user's real-world desk to virtual desk 702, such that the surface of the real-world desk corresponds to the surface of virtual desk 702. Thus, actions taken by the user with respect to the real-world desk can be reproduced in virtual workspace 706 relative to virtual desk 702.

FIG. 7B is a conceptual diagram illustrating an example view 700B of a dynamic XR coworking space 708 from a user's XR device, such as an XR HMD. Dynamic XR coworking space 708 can include multiple virtual workspaces, e.g., virtual workspace 706 of the user, virtual workspace 710 of another user (e.g., having avatar 712), and combined virtual workspace 714. In view 700B, virtual workspaces 706, 710, 714 are visible to other users in dynamic XR coworking space 708, such that the users at virtual workspaces 706, 710, 714 are aware of other users performing work. Avatar 712 can be sitting at virtual desk 716 (e.g., a second virtual object) within virtual workspace 710. The user associated with avatar 712 can be sitting at a real-world desk. Some implementations can map virtual desk 716 to the real-world desk such that a surface of the real-world desk corresponds to a surface of virtual desk 716. Thus, actions taken by the user associated with avatar 712 with respect to the real-world desk can be made at corresponding locations on virtual desk 716. In view 700B, the user associated with avatar 712 can select virtual workspace 706, or an avatar associated with the user of the XR device having view 700B, in order to create a combined virtual workspace 718 of FIG. 7C.

In some implementations, audio generated by the user having view 700B cannot be heard by other users in dynamic XR coworking space 708. In some implementations, audio generated by the user having view 700B can be heard by proximate users (e.g., users having avatars within a threshold distance of an avatar of the user having view 700B), such as the user associated with avatar 712. In some implementations, audio generated by the user having view 700B can be heard at varying volumes across dynamic XR coworking space 708 based on the distance of other users' avatars from the avatar of the user having view 700B, e.g., users having avatars further from the avatar of the user having view 700B can hear audio at a decreased volume with respect to avatars closer to the avatar of the user having view 700B. In some implementations, audio generated by the user having view 700B can be spatial audio as heard by other users on other XR devices.

FIG. 7C is a conceptual diagram illustrating an example view 700C of a combined virtual workspace 718 from a user's XR device (e.g., XR HMD) where the virtual workspace of the user is combined with the virtual workspace of another user corresponding to avatar 712. In response to a request to create combined virtual workspace 718, some implementations can expand virtual desk 702 to include virtual desk 716, thereby forming virtual table 722 (e.g., a third virtual object). Some implementations can map the real-world desk of the user having view 700C and the real-world desk of the user corresponding to avatar 712 to virtual table 722, such that surfaces of the real-world desk have corresponding locations on surfaces of virtual table 722. In view 700C, combined virtual workspace 718 can be seen by other users within dynamic XR coworking space 708 (e.g., the user associated with avatar 724). In some implementations, the user having view 700C and/or the user associated with avatar 712 can exit combined virtual workspace 718, and virtual table 722 can revert to virtual desk 702 for the user having view 700C, as shown in FIG. 7D. Similarly, combined virtual workspace 718 can revert to virtual workspace 706.

FIG. 7D is a conceptual diagram illustrating an example view 700D from a user's XR device (e.g., an XR HMD) of virtual menu 720 to join a combined virtual meeting room 728. In some implementations, the user having view 700D can move their real-world hand (corresponding to virtual hand 726) to make a gesture toward an option on virtual menu 720 to change seats. In some implementations, the user having view 700D can use a real-world controller (e.g., one of controllers 270 of FIG. 2C) to point and select the option to change seats from virtual menu 720. Upon selection of the option from virtual menu 720, the user having view 700D can select where to change seats, as described further herein with respect to FIG. 7E.

FIG. 7E is a conceptual diagram illustrating an example view 700E of a gesture by a user to join a combined virtual meeting room 728 from the user's XR device, such as an XR HMD. In some implementations, the user having view 700E can move their real-world hand (corresponding to virtual hand 726) to motion toward combined virtual meeting room 728. In some implementations, the user having view 700E can use a real-world controller (e.g., one of controllers 270 of FIG. 2C) to point and select combined virtual meeting room 728. View 700E can include an indicator 730 showing where the user is gesturing, such that the user can confirm that she is joining the correct combined virtual meeting room 728.

FIG. 7F is a conceptual diagram illustrating an example view 700F of a combined virtual meeting room 728 from a user's XR device, such as an XR HMD. Some implementations can map the real-world desk of the user having view 700F and the real-world desks of the users corresponding to avatars 712, 734 to virtual table 732, such that surfaces of the real-world desk have corresponding locations on surfaces of virtual table 732. In view 700F, combined virtual meeting room 728 can be seen by other users within dynamic XR coworking space 708. In some implementations, however, combined virtual meeting room 728 can have opaque virtual walls (not shown), such that other users cannot see into combined virtual meeting room 728. In some implementations, audio generated by users within combined virtual meeting room 728 can be shared with other users within combined virtual meeting room 728, but not with other users outside of combined virtual meeting room 728. In some implementations, audio generated by users within combined virtual meeting room 728 can be heard at a lower volume by users outside combined virtual meeting room 728 than those within combined virtual meeting room 728.

FIG. 7G is a conceptual diagram illustrating an example view 700G of a combined virtual meeting room 728 with video conferencing participants 736. In some implementations, users using two-dimensional (2D) interfaces (e.g., computers, mobile phones, etc.) can view a meeting in combined virtual meeting room 728 from their 2D interfaces and participate in the meeting. Users wearing XR devices (e.g., the user having view 700G, the user associated with avatar 712, etc.) can view the video conferencing participants 736 within combined virtual meeting room 728 and exchange audio between both the users wearing XR devices (e.g., XR HMDs) and the users using 2D interfaces. Although described as including video conferencing participants 736, it is contemplated that audio from combined virtual meeting room 728 can also be shared with audio-only participants.

FIG. 8 is a flow diagram illustrating a process 800 used in some implementations of the present technology for providing an artificial reality (XR) coworking space on a two-dimensional (2D) interface. In some implementations, process 800 can be performed as a response to a user request to generate and/or join an XR coworking space. In some implementations, process 800 can be performed as a response to execution of an application on a 2D interface. In some implementations, process 800 can be performed by a remote computing system, e.g., a platform or developer computing system (e.g., a server) located remotely from the 2D interface. In some implementations, process 800 can be performed by XR coworking space system 164 of FIG. 1. In some implementations, process 800 can be performed by a subset of specialized components 430 of FIG. 4.

At block 802, process 800 can generate an XR coworking space. The XR coworking space can be accessed by users via their respective interfaces. In some implementations, the respective interfaces can include 2D interfaces, such as computers, mobile phones, tablets, and/or other user devices configured to display 2D content. In some implementations, the respective interfaces can include three-dimensional (3D) interfaces, such as XR devices. In some implementations, the respective interfaces can include any combination of 2D and 3D interfaces. In some implementations, the XR devices can includes XR head-mounted displays (HMDs), such as XR HMD 200 of FIG. 2A and/or XR HMD 252 of FIG. 2B. The interfaces can render the XR coworking space. For example, the 2D interfaces can render a 2D version of the XR coworking space, while the 3D interfaces can render a 3D version of the XR coworking space. In some implementations, the XR coworking space can be rendered on the 2D interfaces and/or the 3D interfaces without audio, i.e., can be a “quiet” coworking space.

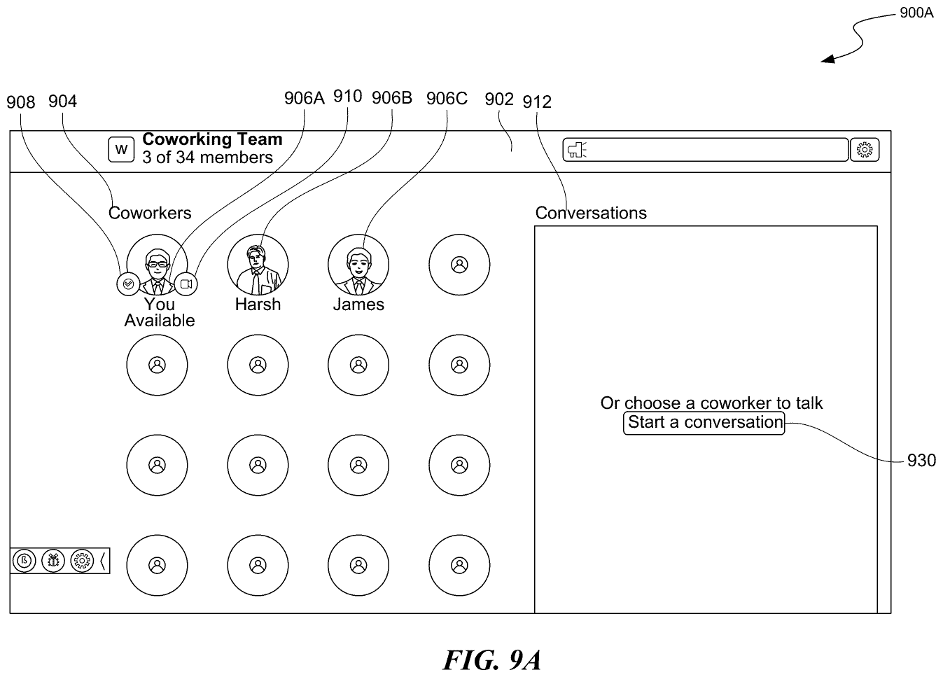

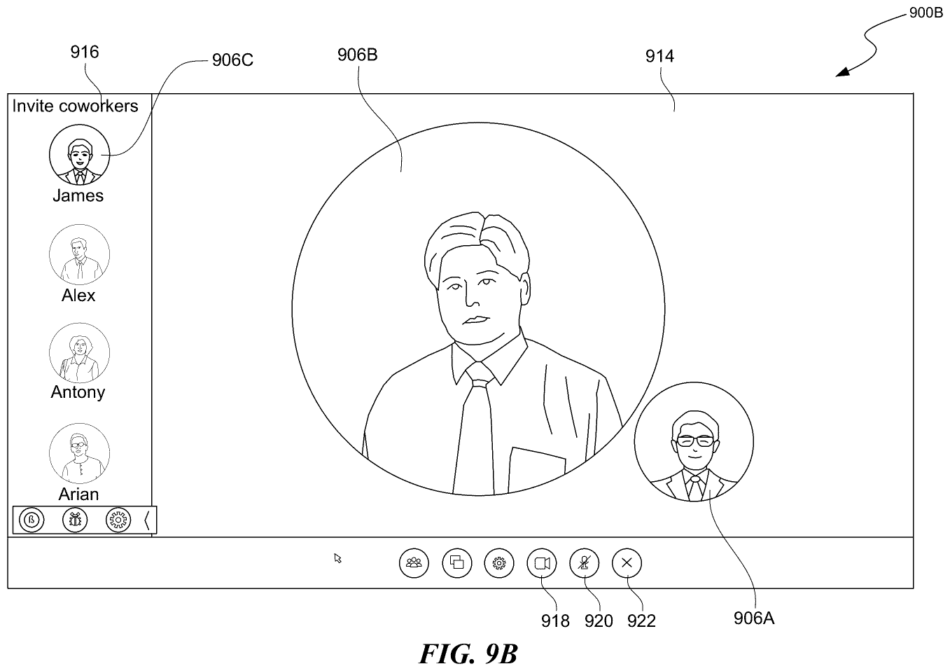

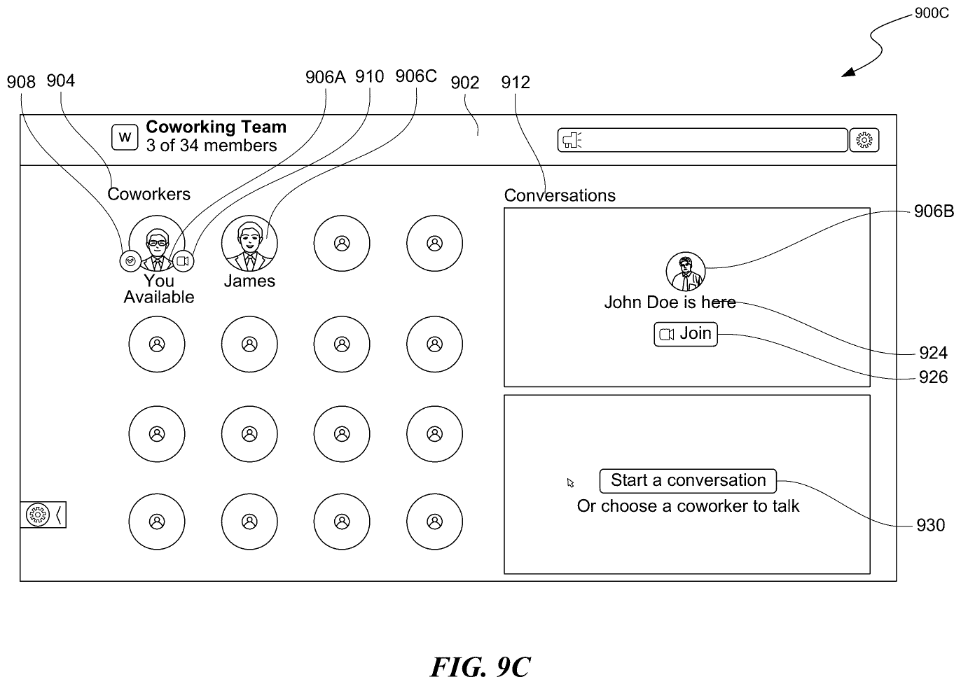

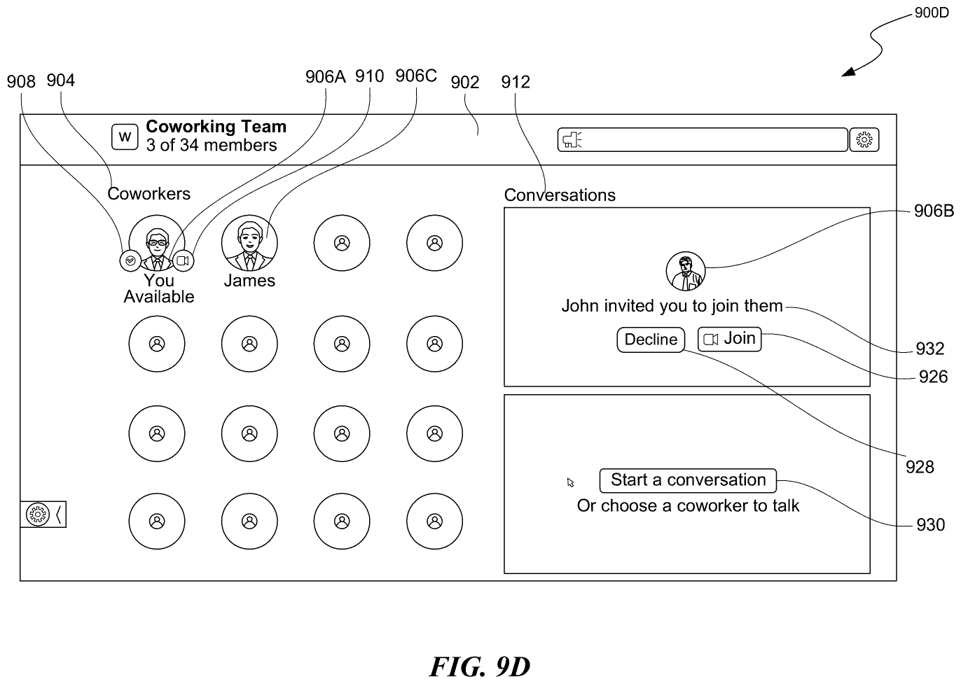

In some implementations, the rendering of the XR coworking space can include visual representations of the users within the XR coworking space. The representations can include, for example, avatars (e.g., graphical representations) of users, photographs of users, live video streams of users while they're working in the XR coworking space, animations, etc., which can be toggled on or off by the users as desired. In some implementations, the avatars can be dynamic and/or animated based on motion of users represented by the avatars. For example, a user accessing the XR coworking space on an XR device can be shown to another user on a 2D interface as a flattened 3D avatar performing work within the XR coworking space. In some implementations, the motion of the user represented by the avatar can be captured by the XR device and/or one or more other XR devices in operable communication with the XR device, which can include one or more cameras, and/or one or more image capture devices external to the XR device. In some implementations, the representations can have a corresponding status indicator for their respective users, e.g., available, busy, away, do not disturb, etc., which can be changed manually and/or automatically based on activity, calendar data, etc. An exemplary XR coworking space is further shown and described with respect to FIG. 9A.

At block 804, process 800 can receive a request from a user via a 2D interface to initiate a conversation with another user. Process 800 can receive the request from the 2D interface over any suitable network, such as network 330 of FIG. 3. In some implementations, the 2D interface can generate the request based on input from the user. The input can be received by the 2D interface via any suitable method, such as, for example, a point-and-click operation (or other indication and selection) on the representation of the other user and/or an option displayed in conjunction with the representation of the other user, an audible announcement (e.g., “I want to start a conversation with Mike”) detected by one or more microphones integral with or in operable communication with the 2D interface and processed via natural language understanding, etc.

At block 806, process 800 can transmit the request to an interface used by the other user to access the XR coworking space, which can be a 2D or 3D interface. Process 800 can transmit the request to the interface used by the other user over any suitable network, such as network 330 of FIG. 3. In some implementations, the interface used by the other user can render the request without audio, i.e., silently deliver the request. In other words, in some implementations, the interface can only provide a visual indication of the request, such that the other user is not intrusively and audibly interrupted from their work when receiving the request. In some implementations, the request can have an expiration period, i.e., the interface can only render the request for a specified threshold duration of time, e.g., 2 minutes, 5 minutes, 10 minutes, etc. In some implementations, process 800 can set such a duration of time such that the other user has time to complete existing tasks that she is working on and respond at their convenience, without having to accept the request “on demand” within a short period of time (e.g., 30 seconds). An exemplary request to join a conversation is shown and described herein with respect to FIG. 9D.

At block 808, process 800 can receive acceptance of the request from the respective interface. Process 800 can receive the acceptance of the request from the respective interface over any suitable network, such as network 330 of FIG. 3. In some implementations, the respective interface can generate acceptance of the request based on input from the other user. The input can be received by the respective interface via any suitable method, such as, for example, a point-and-click operation (or other indication and selection operation) of a “join” or “accept” button displayed on the respective interface, an audible announcement (e.g., “I want to join the conversation with Sarah”) detected by one or more microphones integral with or in operable communication with the respective interface, a gesture (e.g., a thumbs up) detected by one or more cameras integral with or in operable communication with the respective interface, etc.

At block 810, process 800 can generate a virtual conference room. The virtual conference room can be rendered on the 2D interface of the user making the request to initiate the conversation, and the respective interface of the other user accepting the request for conversation. In some implementations, the virtual conference room can be rendered with audio and/or video. In some implementations, while the user and the other user are within the virtual conference room, the XR coworking space (potentially including other users) can show a preview of the virtual conference room that can include, for example, a title of the virtual conference room, a list of attendees within the virtual conference room, etc. In some implementations, the title of the virtual conference room can be indicative of the context of the conversation, e.g., “Water Cooler Chat,” “New Product Brainstorming Session,” etc. In some implementations, a user initiating the conversation can manually set the title of the virtual conference room by entering the title or selecting the title from a list of stored titles (e.g., including previously used titles, commonly used titles, etc.). In some implementations, process 800 can automatically set the title and/or other descriptors in the preview of the virtual conference room by identifying a topic of conversation through, for example, a calendar invitation, and/or performing speech recognition, artificial intelligence, and/or machine learning techniques on keywords identified within the conversation. An exemplary preview of a virtual conference room is shown and described herein with respect to FIG. 9C. An exemplary virtual conference room is shown and described herein with respect to FIG. 9B.

In some implementations, users within the virtual conference room can transition between using a 2D interface and using a 3D interface to access the virtual conference room, such as through a video call/artificial reality (VC/XR) connection system. Such a VC/XR connection system can establish and administer an XR space as a parallel platform for joining a video call. By establishing an XR space connected to the video call, the VC/XR connection system can allow users to easily transition from a typical video call experience to an XR environment connected to the video call, simply by putting on their XR device. Such an XR space can connect to the video call as a call participant, allowing users not participating through the XR space (referred to herein as “video call users” or “video call participants”) to see into the XR space e.g., as if it were a conference room connected to the video call. The video call users can then see how such an XR space facilitates more in-depth communication, prompting them to don their own XR devices to join the XR space. Further details regarding a VC/XR connection system are described in U.S. patent application Ser. No. 17/466,528, filed Sep. 3, 2021, entitled, “Parallel Video Call and Artificial Reality Spaces,” which is herein incorporated by reference in its entirety.

In some implementations, process 800 can further add one or more other users to the virtual conference room. In some implementations, process 800 can add a new user to the virtual conference room upon request by a new user. In some implementations, process 800 can add the new user to the virtual conference room automatically upon request, such that input (i.e., acceptance) of the request is not needed from the user or the other user via their respective interfaces. In some implementations, however, process 800 can transmit the request to the 2D interface and the respective interface, and can add the new user only upon acceptance by the user, the other user, or both, such as in the case of a private virtual conference room.

In some implementations, process 800 can add a new user to the virtual conference room upon acceptance of an invitation generated by the 2D interface, the respective interface of the other user, or both. In some implementation, process 800 can automatically generate the invitation based on one or more features of the conversation, virtual conference room, and/or the new user, such as the title of the virtual conference room, a transcript of the conversation generated while the user and other user are within the virtual conference room, a title or position of the new user, responsibilities of the new user, team of the new user, an existing relationship of the new user to the attendees within the virtual conference room, etc. In some implementations, process 800 can automatically generate the invitation based on results of applying a machine learning model to extracted features of the conversation, virtual conference room, and/or the new user.

In some implementations, users within the virtual conference room can freely leave the virtual conference room and return to the XR coworking space. Similarly, users within the XR coworking space can freely come and go from a conversation or multiple conversations happening within virtual conference rooms. In some implementations, even short audio conversations can take place within a virtual conference room (similar to tapping someone on the shoulder and asking for help), without having to send a textual chat message and waiting for a response. Thus, some implementations are particularly useful for users and teams that are highly collaborative, while being less intrusive than traditional videoconferencing applications.

FIG. 9A is a conceptual diagram illustrating an example view 900A of an XR coworking space 902 on a 2D interface. The 2D interface can be, for example, a computer, a mobile device (e.g., a mobile phone, a tablet, etc.), and/or other user device configured to display virtual objects in two dimensions. In some implementations, XR coworking space 902 can be a “quiet” or “silent” coworking space, with no audio transmitted or received to interfaces being used by users to access XR coworking space 902. XR coworking space 902 can include a coworkers panel 904 and a conversations panel 912.

Coworkers panel 904 can display representations 906A-906C of users within XR coworking space 902. Representation 906A can be a representation of the user having view 900A, and can include a status indicator 908 (e.g., available, busy, away, do not disturb, etc.) and an option 910 to enable or disable video. In this example, the users associated with representations 906A-906B can have option 910 enabled, such that representations 906A-B are video feeds of their respective users working within XR coworking space 902, while representation 906C can be an avatar (e.g., the user associated with representation 906C can have option 910 disabled). Representation 906C can be an avatar of a user using a 2D interface or a 3D interface to access XR coworking space 902. In an example in which representation 906C is an avatar of a user using a 3D interface to access XR coworking space 902, representation 906C can be dynamic, e.g., can move according to how the respective user moves while working within XR coworking space 902, as captured by the 3D interface.

Conversations panel 912 can display any ongoing conversations in virtual conference rooms and can provide an option 930 to start a conversation, that, when selected, can generate a virtual conference room, such as virtual conference room 914 of FIG. 9B. Alternatively, in some implementations, a user can select one or more of representations 906B-906C in order to initiate a conversation in a virtual conference room with their respective user(s), such as in virtual conference room 914 of FIG. 9B.

FIG. 9B is a conceptual diagram illustrating an example view 900B of a virtual conference room 914 on a 2D interface. Virtual conference room can be generated in response to the user associated with representation 906A selecting to start a conversation with the user associated with representation 906B. Virtual conference room 914 can include audio, such that the users associated with representations 906A-906B can speak to each other. In some implementations, the virtual conference room 914 can further include a video feed as representations 906A-906B. Within virtual conference room 914, the user having view 900B can have any of a number of additional options, such as turning on or off the video feed via option 918, turning on or off the audio feed via option 920, exiting virtual conference room 914 via option 922, etc. Virtual conference room 914 can further include invitation panel 916 from which the users within virtual conference room 914 can invite additional users to the conversation by, for example, selecting their respective representations, e.g., representation 906C.

FIG. 9C is a conceptual diagram illustrating an example view 900C of an XR coworking space 902 on a 2D interface while a user, having representation 906B, is within a virtual conference room 914. Within conversations panel 912, view 900C can include an indication that virtual conference room 914 is open along with a preview. The preview can include representation 906B of a user in virtual conference room 914, a name 924 of the user within virtual conference room 914, and an option 926 to join virtual conference room 914. In some implementations, a user within XR coworking space 902 can select option 926 to automatically join virtual conference room 914, without needing permission by the user associated with representation 906B. In some implementations, a user within XR coworking space 902 can select option 926 to send a request to join virtual conference room 914 to the user associated with representation 906B. In some implementations, a user within XR coworking space 902 can select option 930 to start a new conversation separate from that with the user associated with representation 906B.

FIG. 9D is a conceptual diagram illustrating an example view 900D of an XR coworking space 902 on a 2D interface when a user, associated with representation 906B, has sent invitation 932 to join a virtual conference room 914. Within conversations panel 912, invitation 932 can include a preview of virtual conference room 914, including a view of representation 906B associated with the user within virtual conference room 914. Invitation 932 can further include option 926 to join virtual conference room 914, and option 928 to decline to join virtual conference room 914. In some implementations, view 900D can include invitation 932 for only a limited amount of time, such as 5 minutes, 10 minutes, etc. In some implementations, invitation 932 can be rendered within view 900D silently, i.e., without an audible indicator or announcement.

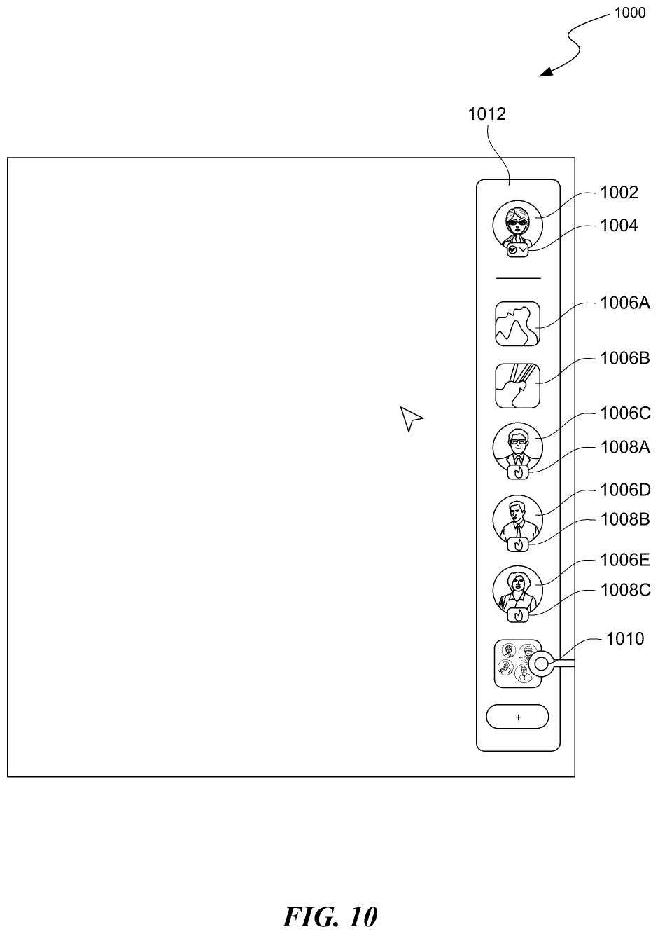

FIG. 10 is a conceptual diagram illustrating an example view 1000 on a 2D interface when an XR coworking space has been minimized. When the XR coworking space is minimized, view 1000 can include bar 1012 in an unobtrusive area of a display screen of the 2D interface, such as on the perimeter, on the far left side, on the top, on the bottom, in a corner, and/or on the far right side, as is shown in view 1000. Bar 1012 can include representation 1002 of the user having view 1000, as well as status indicator 1004, from which the user having view 1000 can indicate whether she is available, busy, away, should not be disturbed, etc. Below representation 1002, view 1000 can include representations 1006A-1006E of other users within the XR coworking space. In some implementations, some of representations 1006A-1006E can further include status indicators 1008A-1008C indicating the status of the user having the respective representation. View 1000 can further include minimized representations 1010 of other users within the XR coworking space, if the number of users within the XR coworking space exceeds available space on bar 1012.

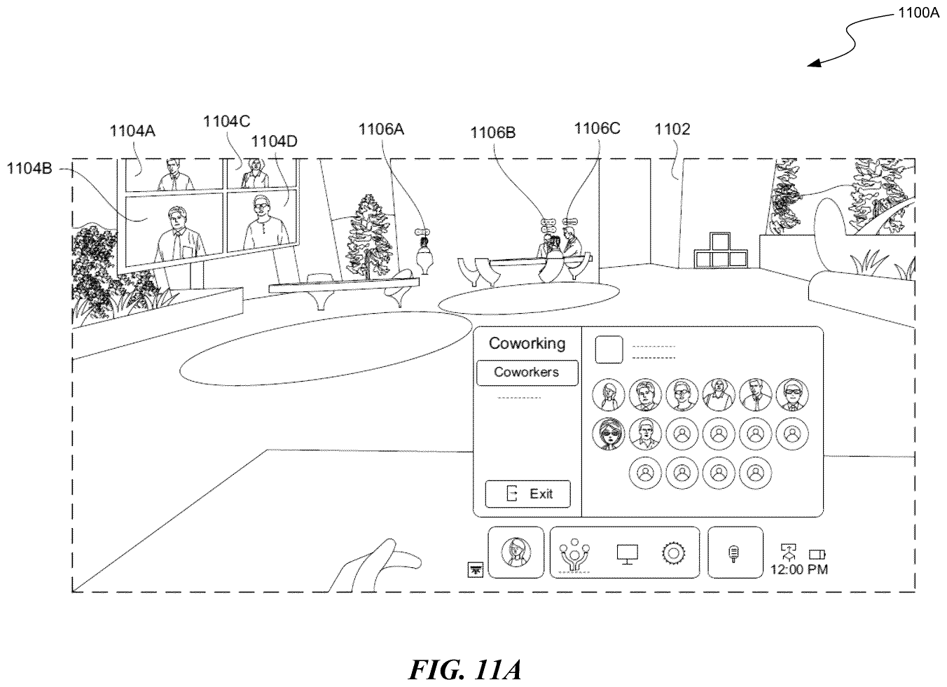

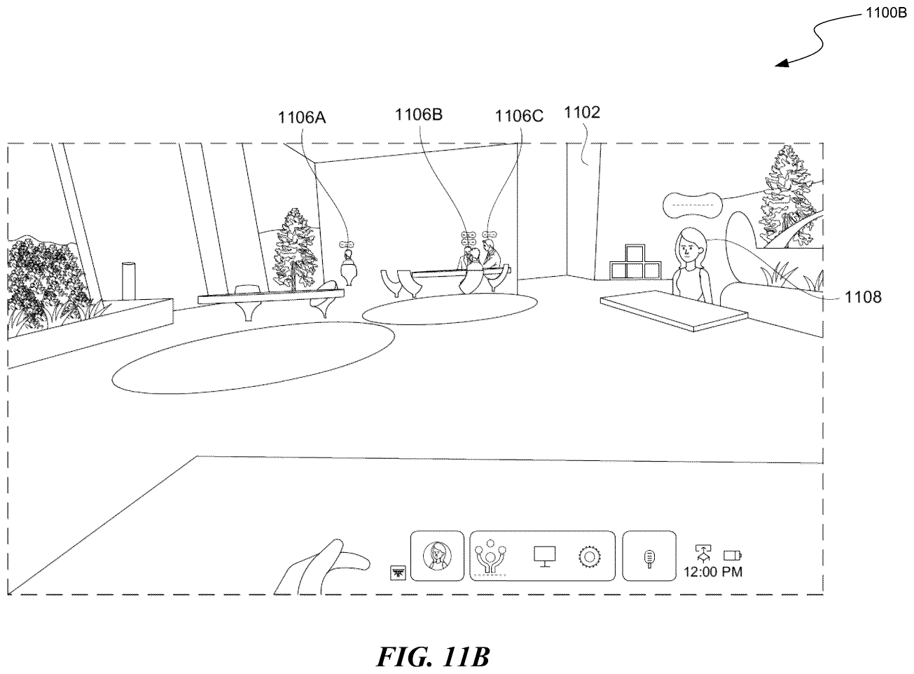

FIG. 11A is a conceptual diagram illustrating an example view 1100A, of an XR coworking space 1102 on a 3D interface, of 2D representations 1104A-1104D of users accessing the XR coworking space 1102 from 2D interfaces. From the 3D interface, view 1100A can be three-dimensional. In some implementations, 3D representations 1106A-1106C can be rendered in view 1100A for users accessing XR coworking space 1102 from 3D interfaces, while 2D representations 1104A-1104D can be rendered in view 1100A for users accessing XR coworking space 1102 from 2D interfaces. Although representations 1104A-1004D are shown as avatars, it is contemplated that representations 1104A-1004D can be similarly rendered in two dimensions as video feeds, i.e., as a video conference.

FIG. 11B is a conceptual diagram illustrating an example view 1100B, of an XR coworking space 1102 on a 3D interface, of a 3D representation of a user accessing the XR coworking space 1102 from a 2D interface. From the 3D interface, view 1100B can be three-dimensional. In some implementations, 3D representations 1106A-1106C can be rendered in view 1100B for users accessing XR coworking space 1102 from 3D interfaces, and 3D representation 1108 can be rendered in view 1100A for a user accessing the XR coworking space 1102 from a 2D interface. In other words, some implementations can translate a 2D representation (e.g., a 2D avatar) of a user of a 2D interface, into a 3D representation (e.g., a 3D avatar) of the user of the 2D interface, such that the user is represented in three dimensions when viewed by a user of a 3D interface.

Reference in this specification to “implementations” (e.g., “some implementations,” “various implementations,” “one implementation,” “an implementation,” etc.) means that a particular feature, structure, or characteristic described in connection with the implementation is included in at least one implementation of the disclosure. The appearances of these phrases in various places in the specification are not necessarily all referring to the same implementation, nor are separate or alternative implementations mutually of other exclusive implementations. Moreover, various features are described which may be exhibited by some implementations and not by others. Similarly, various requirements are described which may be requirements for some implementations but not for other implementations.

As used herein, being above a threshold means that a value for an item under comparison is above a specified other value, that an item under comparison is among a certain specified number of items with the largest value, or that an item under comparison has a value within a specified top percentage value. As used herein, being below a threshold means that a value for an item under comparison is below a specified other value, that an item under comparison is among a certain specified number of items with the smallest value, or that an item under comparison has a value within a specified bottom percentage value. As used herein, being within a threshold means that a value for an item under comparison is between two specified other values, that an item under comparison is among a middle-specified number of items, or that an item under comparison has a value within a middle-specified percentage range. Relative terms, such as high or unimportant, when not otherwise defined, can be understood as assigning a value and determining how that value compares to an established threshold. For example, the phrase “selecting a fast connection” can be understood to mean selecting a connection that has a value assigned corresponding to its connection speed that is above a threshold.

As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

Although the subject matter has been described in language specific to structural features and/or methodological acts, it is to be understood that the subject matter defined in the appended claims is not necessarily limited to the specific features or acts described above. Specific embodiments and implementations have been described herein for purposes of illustration, but various modifications can be made without deviating from the scope of the embodiments and implementations. The specific features and acts described above are disclosed as example forms of implementing the claims that follow. Accordingly, the embodiments and implementations are not limited except as by the appended claims.

Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

I/We claim:

1. A method for providing an artificial reality coworking space on a two-dimensional (2D) interface, the method comprising:
generating the artificial reality coworking space, the artificial reality coworking space being accessed by multiple users via multiple interfaces, the multiple interfaces including at least one 2D interface and at least one three-dimensional (3D) interface, wherein the artificial reality coworking space is rendered on the multiple interfaces with a representation of each of the multiple users accessing the artificial reality coworking space;
receiving a request, from a user of the multiple users, via the 2D interface of the at least one two-dimensional interface, to initiate a conversation with an other user of the multiple users, the other user a respective 3D interface of the at least one 3D interfaces;
transmitting the request, to the respective 3D interface of the multiple interfaces;
receiving acceptance of the request from the respective 3D interface; and
generating a virtual conference room, the virtual conference room being rendered as a 2D view on the 2D interface of the user and as a 3D view on the respective 3D interface of the other user, wherein a preview of the virtual conference room is displayed in the artificial reality coworking space.

2. The method of claim 1, wherein the multiple representations include at least one of an avatar, a photograph, a video stream, or any combination thereof.

3. The method of claim 1, wherein the multiple representations include at least an avatar that is dynamic based on motion of a corresponding respective user of the multiple users.

4. The method of claim 1, wherein the request is rendered on the respective 3D interface without audio.

5. The method of claim 1, wherein the request is rendered on the respective 3D interface for only a threshold period of time.

6. The method of claim 1, wherein the preview includes at least one of a title of the virtual conference room, a list of names of the user and the other user accessing the virtual conference room, or both.

7. The method of claim 1, wherein the virtual conference room is further rendered on the 2D interface and the respective 3D interface of the other user with video.

8. The method of claim 1, further comprising:
adding a third user of the multiple users to the virtual conference room, wherein the third user is added based on either A) acceptance of an invitation generated by the 2D interface of the user, the respective 3D interface of the other user, or both, or B) the third user requesting to join the virtual conference room without input from the 2D interface of the user and the respective 3D interface of the other user.

9. A computer-readable storage medium storing instructions that, when executed by a computing system, cause the computing system to perform a process for providing an artificial reality coworking space on a two-dimensional (2D) interface, the process comprising:
generating the artificial reality coworking space, the artificial reality coworking space being accessed by multiple users via multiple interfaces, the multiple interfaces including at least one 2D interface and at least one three-dimensional (3D) interface, wherein the artificial reality coworking space is rendered on the multiple interfaces with a representation of each of the multiple users accessing the artificial reality coworking space;
receiving a request, from a user of the multiple users, via the 2D interface of the at least one two-dimensional interface, to initiate a conversation with an other user of the multiple users, the other user a respective 3D interface of the at least one 3D interfaces;
transmitting the request, to the respective 3D interface of the multiple interfaces;
receiving acceptance of the request from the respective 3D interface; and
generating a virtual conference room, the virtual conference room being rendered as a 2D view on the 2D interface of the user and as a 3D view on the respective 3D interface of the other user.

10. The computer-readable storage medium of claim 9,
wherein the artificial reality coworking space is rendered on the multiple interfaces without audio, and
wherein the virtual conference room is rendered with audio.

11. The computer-readable storage medium of claim 9,
wherein the artificial reality coworking space is rendered with multiple representations of the respective multiple users accessing the artificial reality coworking space, and
wherein the multiple representations include at least one of an avatar, a photograph, a video stream, or any combination thereof.

12. The computer-readable storage medium of claim 9, wherein the multiple representations include at least an avatar that is dynamic based on motion of a corresponding respective user of the multiple users.

13. The computer-readable storage medium of claim 9, wherein a preview of the virtual conference room is displayed in the artificial reality coworking space.

14. The computer-readable storage medium of claim 13, wherein the preview includes at least one of a title of the virtual conference room, a list of names of the user and the other user accessing the virtual conference room, or both.

15. A computing system for providing an artificial reality coworking space on a two-dimensional (2D) interface, the computing system comprising:
one or more processors; and
one or more memories storing instructions that, when executed by the one or more processors, cause the computing system to perform a process comprising:
generating the artificial reality coworking space, the artificial reality coworking space being accessed by multiple users via multiple interfaces, the multiple interfaces including at least one 2D interface and at least one three-dimensional (3D) interface, wherein the artificial reality coworking space is rendered on the multiple interfaces with a representation of each of the multiple users accessing the artificial reality coworking space;
receiving a request, from a user of the multiple users, via the 2D interface of the at least one two-dimensional interface, to initiate a conversation with an other user of the multiple users, the other user a respective 3D interface of the at least one 3D interfaces;
transmitting the request, to the respective 3D interface of the multiple interfaces;
receiving acceptance of the request from the respective 3D interface; and
generating a virtual conference room, the virtual conference room being rendered as a 2D view on the 2D interface of the user and as a 3D view on the respective 3D interface of the other user.

16. The computing system of claim 15,
wherein the artificial reality coworking space is rendered on the multiple interfaces without audio, and
wherein the virtual conference room is rendered with audio.

17. The computing system of claim 15, wherein the request is rendered on the respective interface without audio.

18. The computing system of claim 17, wherein the request is rendered on the respective interface for only a threshold period of time.

19. The computing system of claim 15, wherein the virtual conference room is further rendered on the 2D interface and the respective 3D interface of the other user with video.

20. The computing system of claim 15, wherein the process further comprises:
adding a third user of the multiple users to the virtual conference room, wherein the third user is added based on either A) acceptance of an invitation generated by the 2D interface of the user, the respective 3D interface of the other user, or both, or B) the third user requesting to join the virtual conference room without input from the 2D interface of the user and the respective 3D interface of the other user.
